(19) United States
(12) Patent Application Publication
(10) Pub. No.: US 2025/0278624 A1
(43) Pub. Date: Sep. 4, 2025

(54) Systems and Methods for Tracking a State of a Device with Continuous-Time Latent Dynamics Learning

(71) Applicant: Mitsubishi Electric Research Laboratories, Inc., Cambridge, MA (US)

(72) Inventors: Pu Wang, Cambridge, MA (US); Sorachi Kato, Cambridge, MA (US); Toshiaki Koike-Akino, Cambridge, MA (US); Petros Boufounos, Cambridge, MA (US)

(73) Assignee: Mitsubishi Electric Research Laboratories, Inc., Cambridge, MA (US)

(21) Appl. No.: 18/593,393

(22) Filed: Mar. 1, 2024

(51) Int. Cl. G06N 3/08; G06N 3/044

(52) U.S. Cl. CPC G06N 3/08; G06N 3/044

(57) ABSTRACT

A method for tracking a state of a device with continuous-time latent dynamics utilizes an artificial intelligence system including a neural network having an autoencoder architecture adapted for dynamic transformation of time series input data from an input state space indicative of the state of the device into an output state space indicative of a state trajectory of the device. The method comprises transforming unsynchronized time-series input data to each neural ordinary differential equation (ODE) subnetworks into time-series latent representations synchronized in time with the time-series latent representations produced by other neural ODE subnetworks. The method also comprises fusing the synchronized time-series latent representations of the multiple neural ODE subnetworks and decoding changes in the state of the device from the fused synchronized time-series latent representations to form the state trajectory of the device.

### TECHNICAL FIELD

The present disclosure relates to tracking systems and more particularly to a system and a method for tracking a state of a device with continuous-time latent dynamics using an autoencoder adapted for dynamic transformation of state space.

### BACKGROUND

Several real-world applications require state space estimation for devices or objects. In this regard, while some solutions utilize data from dedicated sensors, some other solutions follow a secondary approach by utilizing signals and data from secondary sources. The state space can vary based on the applications. Examples of state space include pixel intensities for face recognition applications and temperature values for thermo-comfort applications. For example, state of a device may correspond to the location of the device and can be sensed using the signal fingerprinting approach. However, several hi-tech applications require dynamic transformation of the estimated state space. Examples of such transformation include transforming signal waveforms into locations, temperature into humidity, voltages into currents, etc. Such a transformation is advantageous in many technical fields including location tracking, anomaly detection, smart grid applications, and data completeness applications to name a few. Existing solutions fail to address the intricate requirements of such state space transformation and/or suffer from performance issues when attempting to address the intricate requirements.

In several applications, state space transformation may be utilized for fusion of the transformed states. Such state space transformation with data fusion is usually performed on features extracted from frame-based or sequence-based frameworks. Approaches involving the frame-based framework suffer from low frame rate and irregular sample intervals. Also, such frame-based approaches assume the asynchronous samples to be corresponding to the same stationary label and hence are not applicable for dynamic tasks such as continuous-time object trajectory estimation. On the other hand, state space transformation techniques involving sequence-based framework suffer from timing disparity between two measurement sequences. For example, very often time-series data from multiple sources are non-coherent. The non-coherency may be due to any suitable dimension governing the data, such as due to difference in modality. For example, for the purpose of fusion, data from two sources may be non-coherent when they are asynchronous in time. As such, further processing of such data is constrained due to such forms of non-coherency between them.

Accordingly, improved techniques and processing architectures are required for achieving dynamic, efficient and robust state space transformation for time-series data of a dynamic system.

### SUMMARY

It is an objective of some embodiments to adapt an autoencoder architecture of a neural network to data transformation among different state spaces. It is also an objective of some embodiments to extend the adapted autoencoder architecture to the dynamical systems represented by autoencoders with dynamic latent space. It is also an objective of some embodiments to provide a system and a method for tracking a state of a device with continuous-time latent dynamics using an autoencoder adapted for dynamic transformation of time series input data from an input state space indicative of the state of the device into an output state space indicative of a state trajectory of the device.

Autoencoders are artificial neural networks used to learn efficient embeddings/features of unlabeled data in an unsupervised manner (i.e., without the need for labels). An autoencoder learns two functions: an encoding function, referred to herein as an encoder, which transforms the input data, and a decoding function, referred to herein as a decoder, which reconstructs the input data from the encoded representation. The autoencoder learns an efficient representation (encoding) for a set of data, usually for dimensionality reduction. The encoder transforms each input data point of the input data into a reduced-dimensional representation, which is often referred to as “latent space” or “encoding”. The decoder rebuilds the initial input from the latent space i.e., the decoder is configured to decode each encoded data point from the latent space into an output space to produce the output data. The loss function used during training is typically a reconstruction loss, measuring the difference between the input and the reconstructed output. Common choices include mean squared error (MSE) for continuous data or binary cross-entropy loss for binary data. During training, the autoencoder learns to minimize the reconstruction loss, forcing the network to capture the most important features of the input data in the bottleneck layer.

A state space of the input data to the autoencoder is referred to as input state space and a state space of the output data from the autoencoder is referred to as output state space. The state space can vary based on applications. Examples of the state space include pixel intensities for face recognition applications and temperature values for thermo-comfort applications. But regardless of the applications, the input data and the output data of classical autoencoders belong to the same state space. This “limitation” has been considered a problem instead of a feature of the autoencoder allowing to perform unsupervised training of the autoencoder.

Some embodiments are based on the realization that to address this limitation, the autoencoder needs to be extended to data transformation among different state spaces. Examples of such transformation include transforming signal waveform into locations, temperature into humidity, voltages into currents, etc. Such a transformation is advantageous in many technical fields including location tracking by transforming Wi-Fi signals, anomaly detection, smart grid applications, and data completeness applications.

Some embodiments are based on the realization that such state space transformation among different state spaces can be performed by extending the autoencoder with multiple decoders. To that end, according to an embodiment, the autoencoder includes the encoder, the decoder, and an extended decoder. In some embodiments, the autoencoder includes a plurality of extended decoders. The decoder decodes to the same state space as the input data. The decoder is beneficial for enforcing principles of AI module with the autoencoder. The extended decoders are used to train the encoder to find such latent space that carries information indicative of a partial or full state space of the extended decoder. The objective here is to train the autoencoder to find such a latent space that carries not only information of the state space of the input data but the information indicative of the corresponding data in another state space of interest.

However, some embodiments are based on another realization supported by experiments, that such a state space transformation is not very practical for static data or for static devices. This is because at least in part the latent space carrying information for more than one state space is too small to be reliable. To that end, some embodiments extend the autoencoder to dynamical devices represented by autoencoders with dynamic latent space. The autoencoder extended to the dynamic devices is referred to as a dynamic autoencoder.

In contrast with the static data, the dynamic autoencoder operates on time-series data that carry information about dynamics of the device. The state of such dynamic devices is represented by state variables of different state spaces. Hence, in contrast with the latent space of the autoencoder capturing essence of the input data, a latent space of the dynamic autoencoder can capture the essence of the dynamics. Because different state variables can carry redundant information about the dynamics of the device, the latent space of the dynamic autoencoder can carry information of different state variables in different state spaces allowing the state space transformation.

Inspired by such dynamic autoencoders, some embodiments provide an autoencoder architecture adapted for dynamic transformation of time series input data from an input state space indicative of the state of the device into an output state space indicative of a different state of the device. Some embodiments are also directed towards providing such an autoencoder architecture for each stream of multiple streams of time series input data such that each stream of dynamic time series input data is encoded to a state space that is different from the input state space of the corresponding input data. Some embodiments also realize that several high-end applications may require the output from each autoencoder to be synchronized in time with respect to each other. In this regard, it is an objective of some embodiments to extend an autoencoder architecture having multiple decoders such that one decoder of each such autoencoder is a neural decoder defined on a shared continuous-time axis. In other words, the different neural decoders are defined on a common shared time axis. The shared continuous-time axis forces the neural decoder of each such autoencoder to generate virtual latent dynamic states at the same time instances even though the time series data input to each such autoencoder may be asynchronous with the time series data input to other autoencoders.

Some embodiments are also directed towards fusion based approaches for fusing time synchronized virtual latent dynamic states produced by the neural decoders. Particularly, for robustness and better accuracy, several real-world applications require fusion of data from a plurality of sources. However, meaningful fusion of such data is constrained due to timing disparity between data of two types or from two different sources. For example, two sensors may sample data at different rates and times, thereby leading to asynchronous streams. Some embodiments realize that some data/signal fusion applications may suffer from a problem arising out of the dynamic nature of input data (i.e., sampling time disparity). Particularly, the dynamic input data creates asynchronous timing issues which in turn makes it impossible to fuse them on a frame-to-frame basis.

Some embodiments realized that instead of the static frame-to-frame basis, one approach for addressing the timing disparity is a sequence-to-sequence fusion basis for combining the data/signals. Using the virtual latent dynamic states generated at the same time instances for data from multiple sources, some example embodiments provide measures for combining these synchronized latent dynamic states via a fusion block for challenging applications such as continuous regression and trajectory estimation.

However, some embodiments also realize that sequential signal/data fusion approaches face several challenges arising from sample irregularity, sample asynchrony, and dimension gap between the samples. Input streams of samples may differ greatly in terms of sampling times (time instances at which sample points are collected) as well as sampling intervals (frequency of sample point collection). Also, the granularity of information may differ amongst some samples thereby creating a dimension gap. For example, while one sample may have an information granularity of the order of thousands of elements, some other samples may have it of the order of only few tens of elements. As such, direct concatenation of such samples may lead to sub-optimal solutions since elements of the high granularity sample may dominate over the elements of the low granularity sample.

Some embodiments recognize that quite often, samples for fusion applications are generated from an underlying temporal evolution that represents continuous-time dynamics of a system. In this regard, some example embodiments model the underlying temporal evolution using ordinary differential equations (ODEs). However, it is also a realization of some embodiments that in reality, precise mathematical modelling of such temporal evolutions may not be possible priori, hence the ODEs may also not be possibly defined upfront. Towards this end, some embodiments are directed towards utilizing neural networks to approximate ODEs in the dynamic latent space. In this regard, some example embodiments provide an autoencoder architecture based on principles of neural ODE. Some embodiments also provide a fusion framework utilizing such autoencoders with neural ODEs for generating time synchronized latent dynamic states of multiple time asynchronous input streams and a post-ODE latent fusion block for combining the generated latent states for further processing.

Some embodiments also provide a framework for end-to-end training of the network in a unified manner. The training framework is configurable according to the end objective. For example, for trajectory estimation problems the goal is to minimize coordinate estimation error, and to regulate the latent space to approximate the standard normal distribution [symbol] ˜(0; I) for better latent fusion. Each autoencoder arm caters to an individual sample stream and is trained to independently learn the latent representations (trajectories) for the corresponding sample stream. This enables generation of synchronized latent variables at aligned time instances with a specified dimension. The neural ODE of each autoencoder receives the same sequence of time instances for coordinate estimation and generate latent variables at those points along the learned trajectories. Fusing these variables after the ODE decoders, referred to as post-ODE fusion, provides an enhanced unified latent trajectory; then coordinates are estimated from the fused latent representation obtained from a shared coordinate decoder. The coordinate estimation loss is backpropagated through the whole network, from the shared coordinate decoder back to the ODE encoders for all the input sample streams to achieve the end-to-end training. According to some embodiments, the loss function may be derived based on the evidence lower bound (ELBO) principle, which is a weighted sum of waveform reconstruction losses in asynchronous time instances, coordinate estimation errors in these synchronized time instances, and Kullback-Leibler (KL) divergence loss term that regularizes the distribution.

In order to achieve the aforementioned objectives and the advantages arising therefrom, some embodiments provide an artificial intelligence (AI) system for tracking a state of a device with continuous-time latent dynamics. The AI system includes a neural network having an autoencoder architecture adapted for dynamic transformation of time series input data from an input state space indicative of the state of the device into an output state space indicative of a state trajectory of the device. The AI system comprises at least one processor; and a memory having instructions stored thereon that cause the at least one processor to execute the neural network, train the neural network, or both. The autoencoder architecture comprises multiple neural ordinary differential equation (ODE) subnetworks. Each of the neural ODE subnetworks includes a neural ODE implemented as a recurrent neural network (RNN) architecture transforming unsynchronized time-series input data into time-series latent representations synchronized in time with the time-series latent representations produced by others of the multiple neural ODE subnetworks. The autoencoder architecture also comprises a post-ODE fusion module configured to fuse the synchronized time-series latent representations of the multiple ODE-RNN subnetworks. The autoencoder architecture also comprises a decoder configured to decode changes in the state of the device from the fused synchronized time-series latent representations to form the state trajectory of the device.

Accordingly, another embodiment discloses a method for tracking a state of a device with continuous-time latent dynamics. The method comprises transforming unsynchronized time-series input data to each neural ordinary differential equation (ODE) subnetworks into time-series latent representations synchronized in time with the time-series latent representations produced by other neural ODE subnetworks. The method also comprises fusing the synchronized time-series latent representations of the multiple neural ODE subnetworks and decoding changes in the state of the device from the fused synchronized time-series latent representations to form the state trajectory of the device.

Accordingly, yet another embodiment discloses a non-transitory computer readable storage medium embodied thereon a program executable by a processor for performing a method for tracking a state of a device with continuous-time latent dynamics. The method comprises transforming unsynchronized time-series input data to each neural ODE subnetworks into time-series latent representations synchronized in time with the time-series latent representations produced by other neural ODE subnetworks. The method also comprises fusing the synchronized time-series latent representations of the multiple neural ODE subnetworks and decoding changes in the state of the device from the fused synchronized time-series latent representations to form the state trajectory of the device.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a block diagram of an artificial intelligence (AI) system for tracking a state of a device with continuous-time latent dynamics, according to some embodiments;

FIG. 1B illustrates a flowchart of a method for tracking a state of a device with continuous-time latent dynamics, according to some embodiments;

FIG. 1C illustrates a timing diagram showing timing disparity between two samples of input data to the AI system of FIG. 1A and the corresponding time synchronized latent variables generated by the AI system of FIG. 1A, according to some embodiments;

FIG. 1D illustrates some components of the AI system of FIG. 1A, according to some embodiments;

FIG. 2A illustrates a configuration of the AI system of FIG. 1A for training, according to some embodiments;

FIG. 2B illustrates a training framework for the AI system of FIG. 1A, according to some embodiments;

FIG. 2C illustrates a configuration of a trained AI system at inference, according to some embodiments;

FIG. 3A shows an architecture of an autoencoder, according to some embodiments;

FIG. 3B shows an architecture of an autoencoder with multiple decoders, according to some embodiments;

FIG. 3C illustrates architecture of an autoencoder with a neural Ordinary Differential Equation (ODE), according to some embodiments;

FIG. 4A illustrates a workflow of an ODE-recurrent neural network encoder for generating an initial latent condition in a latent space, according to some embodiments;

FIG. 4B illustrates a workflow for generating time synchronized virtual latent dynamic states from an initial latent condition in a latent space, according to some embodiments;

FIG. 4C illustrates a workflow for performing post-ODE fusion of time synchronized virtual latent dynamic states to generate a unified latent space, according to some embodiments;

FIG. 5 shows a schematic diagram of a computer system executing the AI system of FIG. 1A, according to some embodiments;

FIG. 6 shows an asynchronous neural dynamic fusion framework for multi-band Wi-Fi waveforms for trajectory estimation of an object or device, according to some embodiments;

FIG. 7A illustrates an example use case for indoor localization of a mobile robot in an indoor space using an AI system, according to some embodiments; and

FIG. 7B illustrates an example use case for tracking a location of a vehicle using an AI system, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Several real-world applications require fusion of data to carry out essential operations for one or more tasks. For example, for effective control of autonomous vehicles, image data from different sensors such as LiDARs and RGB cameras is utilized to identify objects in the field of view of the vehicle. In such scenarios, in order to determine a control command for a controller of the vehicle, data from the different sensors needs to be fused for extracting features in the underlying images and correlate them to decide the maneuvers. Similarly, for real-time control of a robot operating in a dynamic industrial setup, it is essential to determine the indoor location of the moving robot or one or more other movable machines to perform efficient manipulations with objects of interest. Such indoor localization may be achieved by fusion of complementary Wi-Fi waveforms communicated by the devices in the industrial environment.

Direct fusion of data of two types or from two sources may not be feasible or practical due to several forms of non-coherency between them. For example, data from two sources or of two types may differ in terms of one or more factors such as modality, sample rates, time asynchrony, etc. As such, some embodiments provide measures for transforming different types of input data into a common state space so as to facilitate meaningful fusion. It is also an objective of various embodiments to synchronize the input data in time in the common state space so as to obtain synchronized states for fusion.

Some embodiments are based on the recognition that samples for fusion applications are generated from an underlying temporal evolution that represents continuous-time dynamics of a system. In this regard, some example embodiments model the underlying temporal evolution using ordinary differential equations (ODEs). However, it is also a realization of some embodiments that in reality, precise mathematical modelling of such temporal evolutions may not be possible priori, hence the ODEs may also not be possibly defined upfront. Towards this end, some embodiments are directed towards utilizing neural networks to approximate ODEs directly from the observed samples. In this regard, some example embodiments provide an autoencoder architecture based on principles of neural ODE. In particular, some embodiments are directed towards utilizing a neural network having an autoencoder architecture adapted for dynamic state transformation of time series input data. Accordingly, some embodiments provide a fusion framework utilizing such autoencoders with neural ODEs for generating time synchronized latent dynamic states of multiple time asynchronous input streams and a post-ODE latent fusion block for combining the generated latent states for further processing tasks such as tracking the state trajectory of a device.

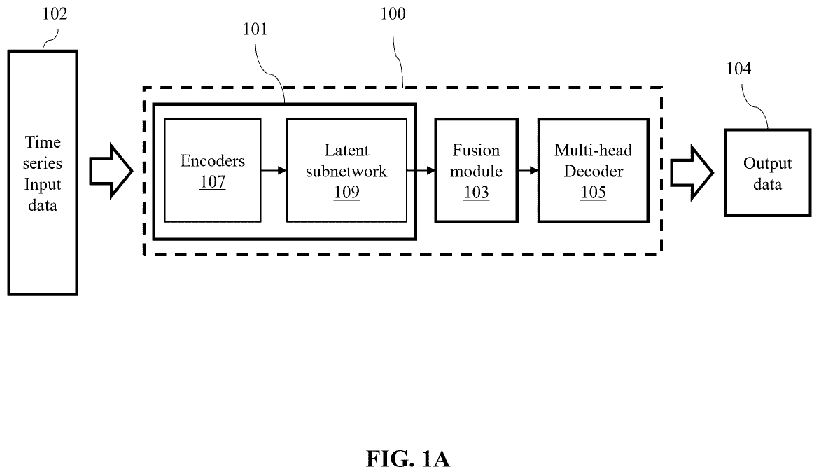

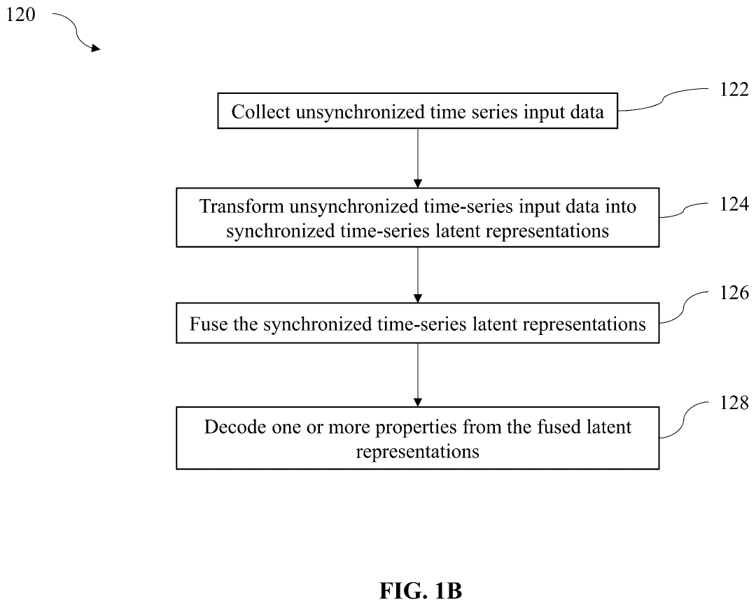

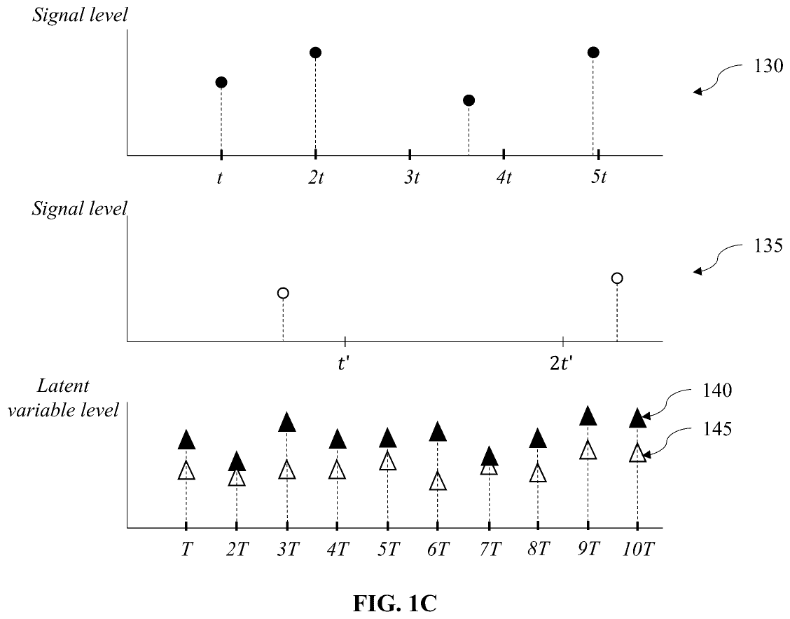

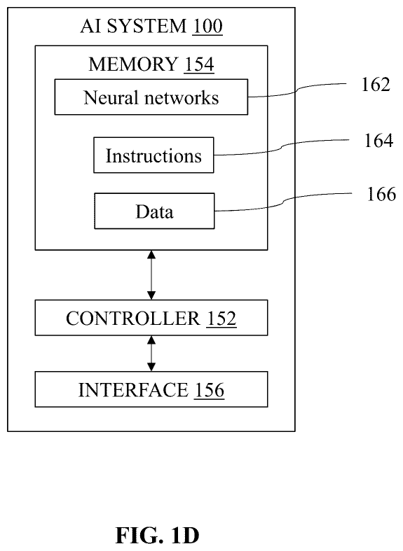

FIG. 1A illustrates a block diagram of an artificial intelligence (AI) system 100 for tracking a state of a device with continuous-time latent dynamics, according to some embodiments. The AI system 100 comprises multiple modules including a plurality of neural ordinary differential equation (ODE) subnetworks 101, a fusion module 103, and a multi-head decoder 105. The different modules of the AI system 100 may be realized in software as computer programs and may be executed by a suitable processing circuitry to carry out the underlying functionalities of each of the modules. The AI system 100 may operate on a plurality of streams of time-series input data 102 provided as an input to the system 100 to generate output data 104. Accordingly, for each stream of the time-series input data 102, some embodiments provide a separate neural ODE subnetwork 101. Each neural ODE subnetwork 101 comprises an encoder 107 along with a latent subnetwork 109 and may be implemented as a recurrent neural network (RNN) architecture. The neural ODE subnetwork 101 transforms each stream of the input data 102 from its input state space to a latent space. The latent states for each input stream are time synchronized with the latent states of other input streams in the latent space.

According to some example embodiments, the time-series input data 102 may include data from a plurality of sources, where each source provides one stream of the time-series input data. For example, the time-series input data 102 may include data from a plurality of sensors capturing one or more parameters of a dynamic system. In some embodiments, the time-series input data 102 may include data of a plurality of types i.e., the data streams in the time-series input data 102 differ from each other in terms of one or more factors such as modality, frame rate, time of capture (time asynchrony) and the like. According to some embodiments, irrespective of the source or type of each data stream in the time-series input data 102, each stream is asynchronous in time with the other streams of the time-series input data 102. Hence, the time-series input data 102 may also be referred to as unsynchronized time-series input data 102.

The output data 104 may include any property, parameter or value that can be extracted from a fusion of the multiple streams of the time-series input data 102. For example, the output data 104 may represent a state trajectory of a device for which the time-series input data 102 corresponds to wireless signals transmitted by the device and measured by different receivers. In some other embodiments, the output data 104 may represent a location of a device that communicates with a plurality of other devices. In yet some other embodiments, the output data 104 may include features extracted from a composite image which in turn is obtained from a fusion of sensor data from a plurality of sensors. The output data 104 is dependent on the end use for which the AI system 100 is trained and deployed.

The operation of the AI system 100 for tracking a state of a device having continuous time dynamics is described next with reference to FIG. 1B which illustrates a flowchart of a method 120 for tracking a state of a device with continuous-time dynamics, according to some embodiments. The unsynchronized time-series input data 102 for a device is collected 122 and provided to the AI system 100. For each stream of the time-series input data 102, the AI system 100 comprises a separate neural ODE subnetwork 101. The neural ODE subnetworks 101 (i.e., the encoder 107 together with the latent subnetwork 109) transforms 124 the unsynchronized time-series input data 102 into synchronized time-series latent representations. That is, the time-series latent representations for a stream of the time-series input data 102 are synchronized in time with the time-series latent representations of other streams of the time-series input data 102.

In this regard, the encoder 107 encodes each input data point of a stream from an input state space into a latent space to produce latent data points indexed in time according to time indices of the input data points of the stream. The input data points in each stream are indexed in the forward direction (t₀, . . . , t_{N}) i.e., the first data point in a stream is fed to the encoder 101 first. Therefore, the latent data points are also indexed in time (t₀, . . . , t_{N}) according to time indices of the corresponding input data points. The encoder 107 propagates the latent data points backward in time (t_{N}, . . . , t₀) with a neural ODE approximating dynamics of the device in the latent space to estimate an initial point of latent dynamics of the device in the latent space. The latent subnetwork 109 propagates the initial point of latent dynamics of the device forward in time till time indices of interest using the neural ODE to produce the time-series latent representations of the state trajectory of the device at the time indices of interest. The time indices of interest may be provided as a reference time-axis that has time indices defined in a periodic manner.

Referring back to FIG. 1A and 1B, the time-series latent representations of the state trajectory of the device generated by each of the neural ODE subnetworks 101 is provided to the fusion module 103 for fusing 126 the synchronized time-series latent representations. Since the fusion module succeeds the neural ODE subnetworks 101, it may also be referred to as a post-ODE fusion module 103. In order to fuse the synchronized time-series latent representations, the post-ODE fusion module 103 projects each latent state of each latent representation into higher dimensions and concatenates the projected latent states at each time instance of the time indices of interest to obtain a fused latent state at each time instance.

The multi-head decoder 105 is also implemented as a neural network and comprises a plurality of decoders-one each for reconstructing each input stream of the time-series input data, and a feature decoder for decoding 128 one or more features/properties for the device from the fused latent state generated by the fusion module 103. For example, for tracking the state of the device, the feature decoder may be a coordinate decoder that projects the fused latent states to a plurality of coordinate estimates for the device.

FIG. 1C illustrates a timing diagram showing timing disparity between two streams 130 and 135 of input data 102 to the AI system of FIG. 1A and the corresponding time synchronized latent variables 140, 145 generated by the AI system of FIG. 1A, according to some embodiments. The input stream 130 has non-periodic data captures at time instances t, 2t, 3.75t, and 4.95t while the input stream 135 has non-periodic data captures at time instances 0.75t′ and 2.25t′ where t′ is greater than t. The two streams 130 and 135 differ in terms of frame rates as well as timing of capture and are therefore asynchronous in time. However, for some given time indices of interest having a frame rate T, corresponding to the input stream 130 the latent variables generated by its neural ODE subnetwork are shown as dark shaded triangles 140 while corresponding to the input stream 135 the latent variables generated by its neural ODE subnetwork are shown as unshaded triangles 145. At each instance of time of the time indices of interest, there exists a latent variable for each of the input streams 130 and 135.

FIG. 1D illustrates some components of the AI system 100 of FIG. 1A, according to some embodiments. The system 100 comprises a controller 152, a memory 154, and an interface 156. The controller 152 accesses the memory 154 to execute a training process and/or the method 120 for the system 150. The memory 154 stores, amongst other things, different modules of the AI system 100 as discussed with reference to FIGS. 1A and 1B. In particular, the memory 154 stores various neural networks 162, computer executable instructions 164 and data 166 all of which are accessible to the controller 152. The controller 152 invokes the modules and data during training and/or execution phases. The controller communicates input and output data of the system 100 through one or more interfaces 156.

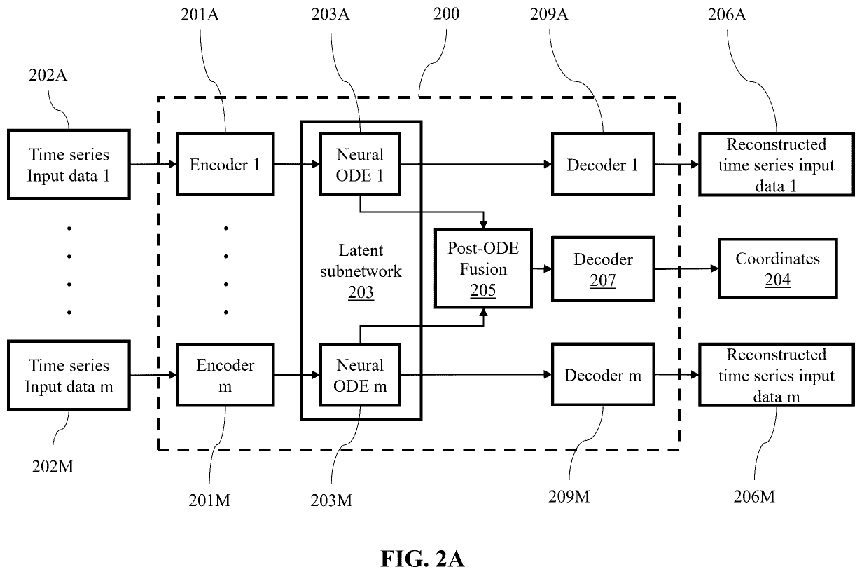

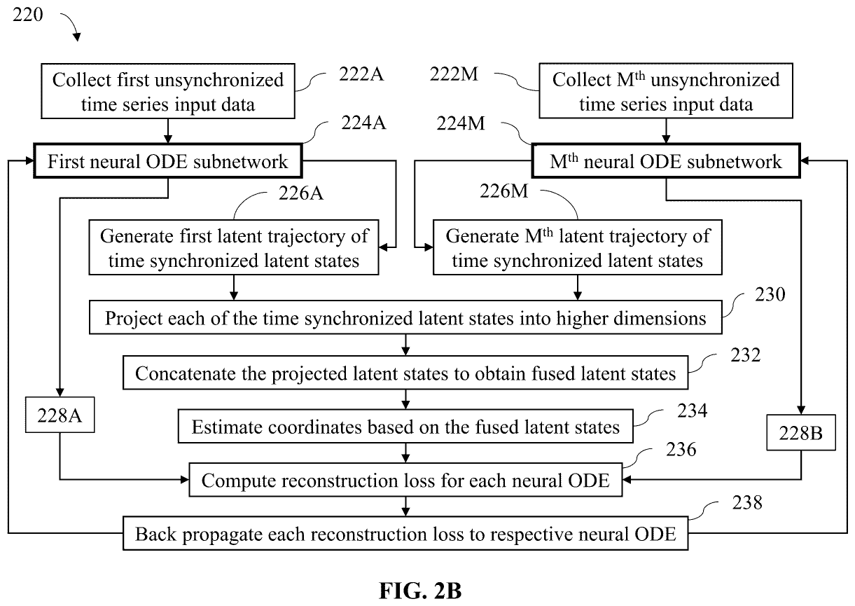

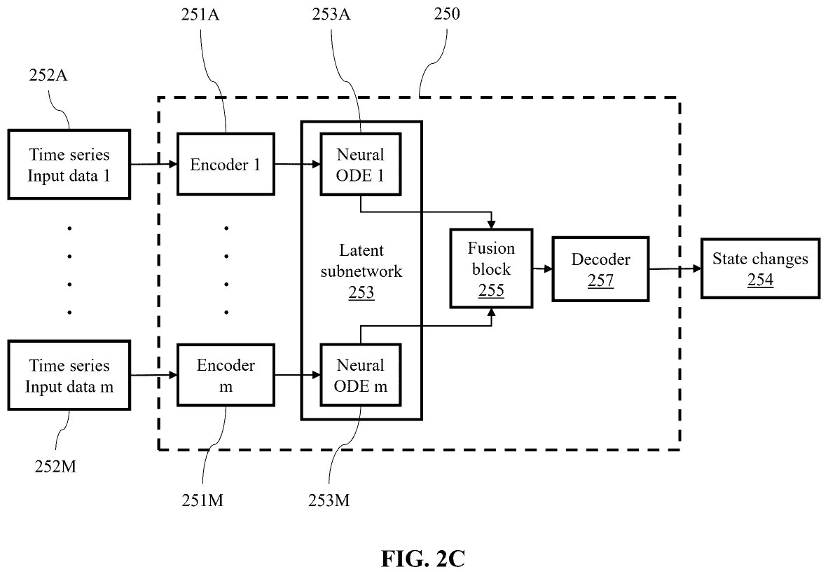

FIG. 2A illustrates a configuration of the AI system 100 of FIG. 1A for training, according to some embodiments. The system 100 during training is referred herein as AI system 200. The configuration of the AI system 200 remains similar to that of the AI system 100 with greater emphasis laid on the multi-head decoder and the latent dynamic subnetwork. The training configuration is described in detail in conjunction with FIG. 2B which illustrates a training framework 220 for the AI system of FIG. 1A, according to some embodiments.

According to some embodiments, the framework 220 is an end-to-end training framework for the neural network architecture of the AI system 200 and operates in a unified manner. The training framework is configurable according to the end objective. For example, for trajectory estimation problems the goal may be to minimize coordinate estimation error, and to regulate the latent space to approximate the standard normal distribution [symbol] ˜(0; I) for better latent fusion. Each autoencoder arm is realized with a separate encoder of the encoders 201A-201M and a separate neural ODE of the neural ODEs 203A-203M. As is shown in FIG. 2A, each such autoencoder caters to an individual sample stream of the time-series input data 202A-202M and is trained to independently learn the latent representations (trajectories) for the corresponding sample stream. This enables generation of synchronized latent variables at aligned time instances with a specified dimension. The neural ODE of each autoencoder receives the same sequence of time instances for coordinate estimation and generates latent variables at those points along the learned trajectories.

Referring to FIG. 2A and 2B, the training framework 220 comprises collecting (222A-222M) unsynchronized time-series input data having multiple streams. In this regard, the collection step includes a plurality of sub steps of collecting each stream (first stream, second stream . . . M^{th} stream) of the unsynchronized time-series input data. Each stream of the input data is processed using a separate neural ODE subnetwork i.e., the first stream collected at 222A is processed using the neural ODE subnetwork 224A while the Mth stream collected at 222M is processed using the neural ODE subnetwork 224M and so on.

Each of the neural ODE subnetworks 224A-224M transform a respective stream of the input data from its input state space to a latent space. The latent states for each input stream are time synchronized with the latent states of other input streams in the latent space. The neural ODE of each autoencoder receives the same sequence of time instances for coordinate estimation and generates latent variables at those points along the learned trajectories. The latent states thus generated for each stream leads to generation (226A-226M) of a latent trajectory of time synchronized latent states corresponding to each input stream. Additionally, each of the neural ODE subnetworks (224A-224M) also comprises a decoder 209A-209M for reconstructing the corresponding input data stream from the corresponding latent states/variables. Thus, for each stream of input data 202A-202M, a reconstructed input data stream or reconstructed time-series input data (206A-206M) is provided at step 228A-228M.

Fusing the latent variables after the ODE decoders of the neural ODE subnetwork at a post-ODE fusion block 205, provides an enhanced unified latent trajectory. In this regard, at step 230, the training framework 220 projects each of the time synchronized latent states generated at steps 226A-226M into higher dimensions. In this regard, some embodiments utilize learnable matrices for the projection. In some embodiments, the learnable matrices may be different for the latent states of each input stream. The choice of the higher dimension for latent states of a particular input stream may be specified according to end objective of the fusion task and is hence configurable.

At each instance of the given time indices of interest, the projected latent states are concatenated 232 and finally compressed to obtain a fused latent state using another learnable weights and biases. According to some embodiments, the given time indices may be predefined, or user defined. Alternately, in some embodiments the time indices may be configurable based on the downstream task for which fusion of the streams is performed. According to some embodiments, the latent fusion block 205 is time-independent and shared across all time instances. Thus, the fused latent state obtained for each instance of the time indices of interest constitutes a fused latent representation from which the coordinates 204 of the device are estimated 234 by a shared coordinate decoder 207. Using the coordinates 204 obtained at step 234 and the trajectory generated from the reconstructed input data stream (206A-206M) at step 228A-228M, a reconstruction loss is computed 236 for each of the neural ODEs. The coordinate estimation loss is backpropagated through the whole network, from the shared coordinate decoder 207 back to the ODE encoders 224A-224M for all the input sample streams to achieve the end-to-end training. According to some embodiments, the loss function may be derived based on the evidence lower bound (ELBO) principle, which is a weighted sum of waveform reconstruction losses in asynchronous time instances, coordinate estimation errors in these synchronized time instances, and Kullback-Leibler (KL) divergence loss term that regularizes the distribution.

Some embodiments train the latent dynamic ODEs (i.e., the neural ODEs 203A-203M) in a supervised manner with input stream reconstruction (signal or waveform reconstruction) and coordinate estimation, so that each neural ODE captures the temporal evolution of latent representation while considering the relationship between signal propagation and physical object's locations. In this regard, some embodiments utilize a multi-head decoding structure that consists of separate MLP heads for signal and coordinate decoding. Also, according to some embodiments, each reconstruction loss or error between the coordinates estimated at step 234 and the ground truth provided from respective signal reconstruction at step 228A is propagated back to the respective ones of the latent dynamic ODEs (203A-203M) through the gradient. In this way, each of the latent dynamic ODEs complementarily exchange amongst each other, information about the dynamics they have learned through the supervised learning of the coordinates.

A configuration of the AI system 100 after training does not include the decoders 209A-209M for signal reconstruction. FIG. 2C illustrates one such configuration of a trained AI system 250 at inference, according to some embodiments. The modules of the trained AI system 250 include trained encoders 251A-251M, a trained latent subnetwork 253 including trained neural ODEs 253A-253M and a fusion block 255 that is shared at all time instances. The trained AI system 250 also includes the coordinate decoder 257 that decodes the state changes 254 from the fused latent representations generated by the fusion block 255.

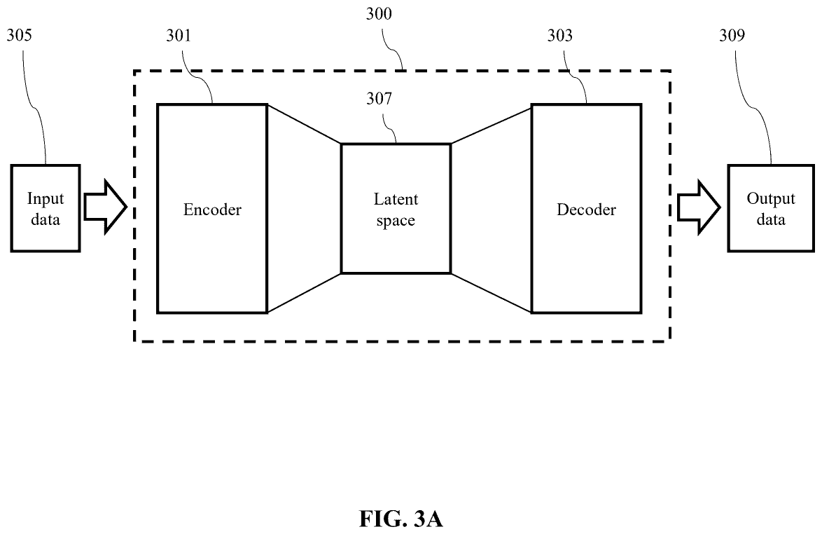

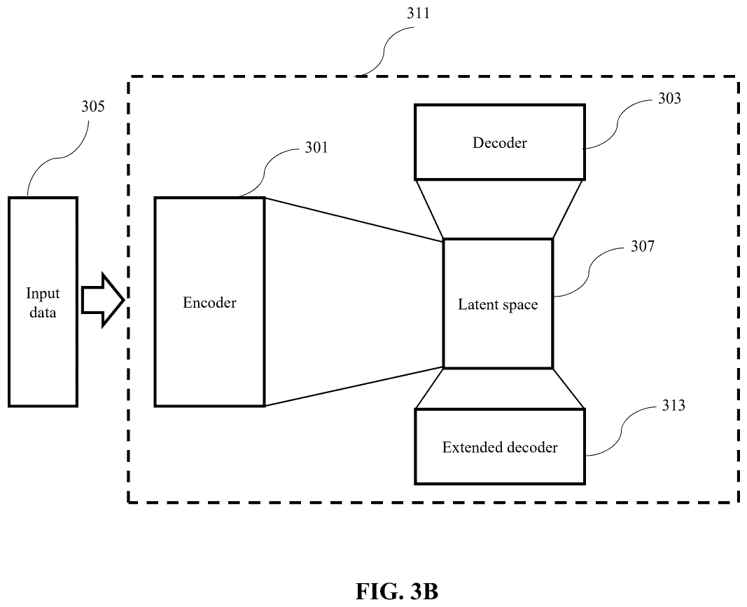

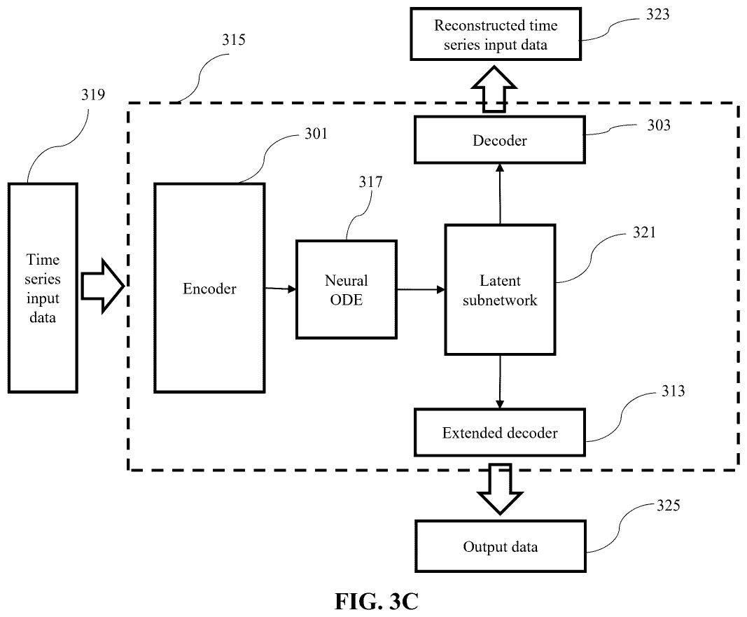

According to some embodiments, the various modules of the AI system 100/200/250 are realized through autoencoders. A detailed description of autoencoders provided by various embodiments is provided next with reference to FIGS. 3A-3C.

Autoencoders are artificial neural networks used to learn efficient embeddings/features of unlabeled data in an unsupervised manner (i.e., without the need for labels). Autoencoders emerge as a fascinating subset of neural networks, offering a unique approach to unsupervised learning. Autoencoders are an adaptable and strong class of architectures for the dynamic field of deep learning, where neural networks develop constantly to identify complicated patterns and representations. With their ability to learn effective representations of data, these unsupervised learning models have received considerable attention and are useful in a wide variety of areas, from image processing to anomaly detection.

An autoencoder learns an efficient representation (encoding) for a set of data, usually for dimensionality reduction. The encoder transforms each input data point of the input data into a reduced-dimensional representation, which is often referred to as “latent space” or “encoding”. The decoder rebuilds the initial input from the latent space i.e., the decoder is configured to decode each encoded data point from the latent space into an output space to produce the output data. A state space of the input data to the autoencoder is referred to as input state space and a state space of the output data from the autoencoder is referred to as output state space. The loss function used during training of an autoencoder may be a reconstruction loss, measuring the difference between the input and the reconstructed output. Common choices include mean squared error (MSE) for continuous data or binary cross-entropy for binary data. During training, the autoencoder learns to minimize the reconstruction loss, forcing the network to capture the most important features of the input data in the bottleneck layer. However, for autoencoders the input data and the output data belong to the same state space. This limitation inhibits adoption of autoencoders for many critical applications such as fusion based approaches since such approaches typically require the different types of data to be in a common state space.

Some example embodiments provided herein adapt the architecture of autoencoders for dynamic transformation of data among different state spaces. Such a transformation is advantageous in many technical fields including location tracking by transforming Wi-Fi signals, anomaly detection, smart grid applications, and data completeness applications. According to some embodiments, the adapted autoencoder transforms data from an input state space into an output state space. For example, the input state space may be indicative of the state of a device or object while the output state space may be indicative of some meaningful data such as a state trajectory of the device or object. According to some embodiments, the autoencoder is specifically adapted for operating on time-series input data of dynamical systems and as such the output state space for such autoencoders may be a dynamic latent space. The time-series input data of such systems carry information about dynamics of the system. The state of such dynamic systems is represented by state variables of different state spaces. Hence, in contrast with the latent space of the classical autoencoder capturing essence of the input data, a latent space of the dynamic autoencoder according to some embodiments can capture the essence of the dynamics. Also, since different state variables can carry redundant information about the dynamics of the device, the latent space of the dynamic autoencoder according to some embodiments can carry information of different state variables in different state spaces allowing the state space transformation.

FIG. 3A shows an architecture of an autoencoder 300, according to some embodiments of the present disclosure. An autoencoder is a type of artificial neural network used to learn efficient encodings of unlabeled data (unsupervised learning). The autoencoder 300 includes an encoder 301 and a decoder 303. The encoder 301 is configured to encode each input data point of input data 305 from an input space into a latent space 307. The decoder 303 is configured to decode each encoded data point from the latent space into an output space to produce the output data 309. One of the fundamental features of the autoencoder 300 is that the input data 305 and the output data 309 belong to the same state space. A state space of the input data 305 is referred to as input state space and a state space of the output data 309 is referred to as output state space. The state space can vary based on applications. Examples of the state space include pixel intensities for face recognition applications and temperature values for thermo-comfort applications. But regardless of the applications, the input data 305 and the output data 309 of the autoencoder 300 belong to the same state space.

However, it is an objective of some embodiments to address this limitation to extend the autoencoder 300 to data transformation among different state spaces. Examples of such transformation include transforming signal waveform into locations, temperature into humidity, voltages into currents, etc. Such a transformation is advantageous in many technical fields including location tracking by transforming Wi-Fi signals, anomaly detection, smart grid applications, and data completeness applications.

Some embodiments are based on the realization that such state space transformation can be performed by extending the autoencoder 300 with multiple decoders. The autoencoder 300 extended with multiple decoders is described below in FIG. 3B.

FIG. 3B shows the architecture of an autoencoder 311 with multiple decoders, according to an embodiment. The autoencoder 311 includes the encoder 301, the decoder 303, and an extended decoder 313.The decoder 303 decodes to the same state space as the input data 305. The decoder 303 is beneficial for enforcing principles of AI module with the autoencoder 311. The extended decoder 313 is used to train the encoder 301 to find such latent space that carries information indicative of a state space of the extended decoder 313. The objective here is to train the autoencoder 311 to find such a latent space that carries not only information of the state space of the input data 305 but the information indicative of the corresponding data in another state space of interest.

However, some embodiments are based on another realization supported by experiments, that such a state space transformation is not very practical for static data or for static devices. This is because at least in part the latent space carrying information for more than one state space is too small to be reliable. To that end, some embodiments extended the autoencoder 311 to dynamical devices represented by autoencoders with dynamic latent space. The autoencoder 311 extended to the dynamical devices is referred to as a dynamic autoencoder.

In contrast with the static data, the dynamic autoencoder operates on time-series data that carry information about dynamics of the device. The state of such dynamic devices is represented by state variables of different state spaces. Hence, in contrast with the latent space 307 of the autoencoder 311 capturing essence of the input data 305, a latent space of the dynamic autoencoder can capture the essence of the dynamics. Because different state variables can carry redundant information about the dynamics of the device, the latent space of the dynamic autoencoder can carry information of different state variables in different state spaces allowing the state space transformation.

Some embodiments are based on the observation that to train such a dynamic autoencoder with multiple decoders decoding into different state spaces, there is a need to have labeled training data in a subset of the state space different from the input state space. The labeled training data necessitates supervised machine learning and is usually difficult to get. Hence, while in theory, any dynamical autoencoder can be extended to the multiple decoders to adapt the dynamic autoencoder to the state space transformation, in practice can be a significant imbalance between unlabeled training data from the input state space and labeled training data from a desired output state space.

To that end, it is an objective of some embodiments to adapt the dynamic autoencoder to imbalanced training with multiple decoders decoding into different and complementary state spaces. The imbalanced training includes one or a combination of different amounts of training data in different state spaces, a different time resolution of the training data in the different state spaces, a different quantization of the training data in the different state spaces, and a different time alignment of the training data in different state spaces.

Some embodiments are based on the realization that such imbalanced training can be performed for a state of the device with continuous-time dynamics because continuation of the dynamics makes the imbalance of the training data irrelevant. However, the dynamic autoencoder has a discrete nature to operations. To that end, there is a need to transform the dynamic autoencoder to capture continuous nature of the continuous-time dynamics of the device for any imbalances of the training data.

Some embodiments are based on the realization that the continuous-time dynamics can be defined by Ordinary Differential Equations (ODEs) and the ODEs can be designed with help of a neural network to capture the continuous-time dynamics in the latent space. To that end, some embodiments use the autoencoder using neural ODEs capturing the continuous-time dynamics of the device in the latent space. Doing this in such a manner allows for imbalance training of the autoencoder during training stage, and the state space transformation during inference stage.

FIG. 3C illustrates an autoencoder 315 with a neural ODE 317, according to some embodiments. The autoencoder 315 is configured for dynamic transformation of time series input data 319 from an input state space indicative of the state of the device into an output state space indicative of the state of the device. The state of the device, for example, includes the location of the device. The autoencoder 315 includes an encoder 301, the neural ODE 317, a latent subnetwork 321, the decoder 303, the extended decoder 313. The encoder 301 is configured to encode each input data point of the time series input data 319 from the input state space into a latent space to produce latent data points indexed in time according to time indices of corresponding input data points. The encoder 301 is further configured to propagate the latent data points backward in time with the neural ODE 317 approximating dynamics of the device in the latent space to estimate an initial point of latent dynamics of the device in the latent space.

The latent subnetwork 321 is configured to propagate the initial point of latent dynamics of the device forward in time till a time index of interest using the neural ODE 317 to produce a state of latent dynamics of the device at the time index of interest. The decoder 303 is configured to the state of latent dynamics of the device into a state space same as the input state space to reconstruct the time series input data. To that end, the decoder 303 outputs reconstructed time series input data 323. The extended decoder 313 is configured to decode the state of latent dynamics of the device into the output state space different from the input state space to produce output data 325 including the state of the device at the time index of interest.

Thus, using one neural ODE based autoencoder 315 (also referred to as an adapted autoencoder) for each type of unsynchronized time-series input data can provide time synchronized latent states which can then be fused for further processing. Also, fusion based applications operate on multiple streams of input data. For example, for an autonomous driving-based application, there may be an input stream of data from each sensor of the vehicle. According to some embodiments, for such fusion based applications, the adapted autoencoder architecture is provided for each stream of time series input data, resulting in a neural network architecture having multiple adapted autoencoders. Also, the output from each adapted autoencoder is synchronized in time with the output of other adapted autoencoders. In this regard, it is an objective of some embodiments to extend an autoencoder architecture having multiple decoders such that one decoder of each such autoencoder is a neural decoder defined on a shared continuous-time axis.

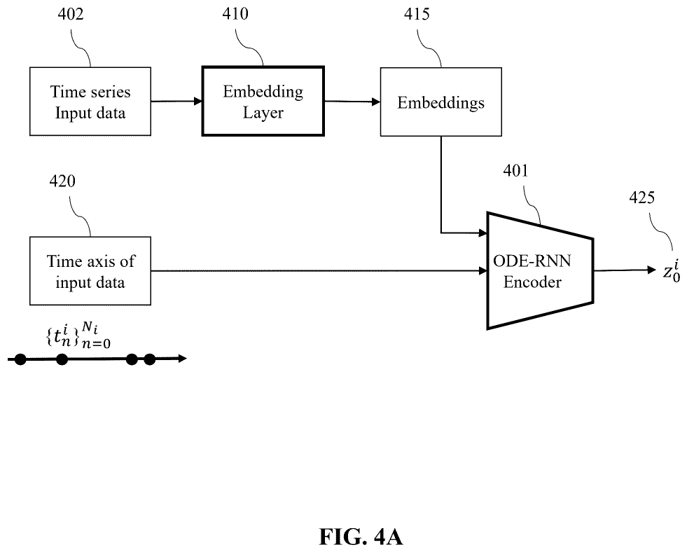

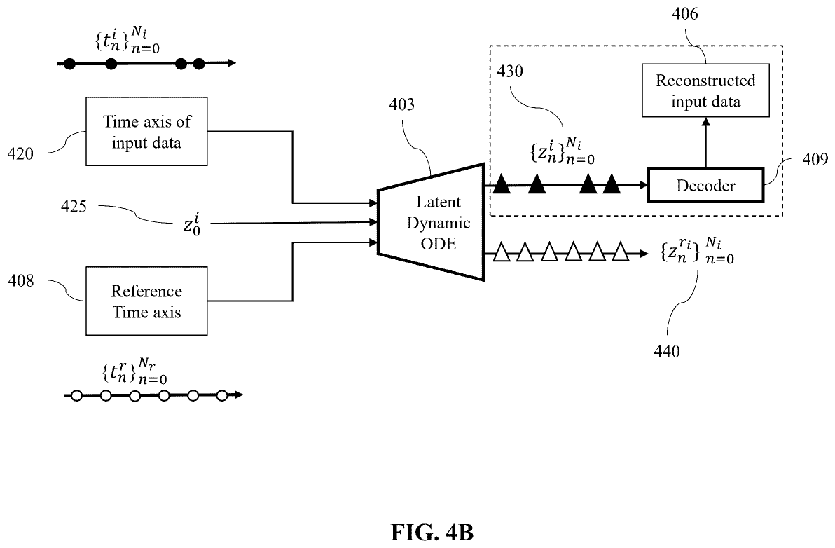

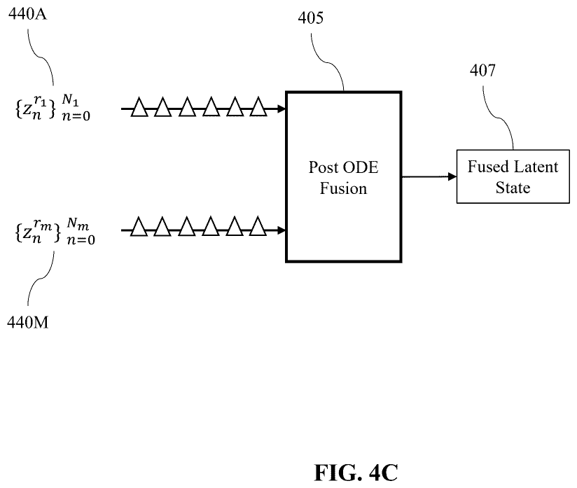

A detailed working of each component of the AI system 100 of FIG. 1A will now be described with particular reference to FIGS. 4A-4C.

FIG. 4A illustrates a workflow of an ODE-recurrent neural network (ODE-RNN) encoder 401 for generating an initial latent condition in a latent space. According to some embodiments, the time-series input data 402 may be pre-processed according to end use requirements, for example to aid in a meaningful fusion of the states for tracking the state of the device. For instance, the time-series input data may suffer from inevitable phase offsets, noise, and/or other imperfections. The pre-processing may be performed to remove or reduce the effects caused by the imperfections. Additionally, or optionally, to reduce the dimensionality gap between different streams of the input data 402, embeddings 415 of the input data 402 may be generated by one or more embedding layers 410. These embedding layers 410 ensure that meaningful data in a stream is preserved to the greatest extent possible while reducing the dimensionality of the stream. In this regard, some embodiments provide a convolutional autoencoder ε_{θ}_{ᵢ}={ε_{θ}_{ᵢ}_{^{e}}, ε_{θ}_{ᵢ}_{^{d}}} where ε_{θ}_{ᵢ}_{^{e}}, ε_{θ}_{ᵢ}_{^{d}} are an encoder and decoder respectively. The trained autoencoder provides embedded features 415 as

$${ε}_{{θ}_{i}^{e}} ( {i}_{n} ) = , ∈ {ℝ}^{{M}_{i} \times 1} \qquad ( 1 )$$

where iₙ is the input sequence of an input stream i of the time-series input data 402, Mi is the length of the embedded feature 415 of an input stream i of the time-series input data 402.

The ODE-RNN encoder 401 aims at obtaining the posterior distribution over the latent representation of a trajectory's starting point, conditioned on the input signal sequence. Let {sₙ, tₙ^{s}}ₙ₌₀^{N}, sₙ∈ [symbol] ^{K×1} be the set of an arbitrary signal sequence and the corresponding time instances, and let the dimension of the single signal K be arbitrary. The encoder 401 takes the reversed input sequences s_{N}, s_{N-1}, . . . , s₀ to estimate the initial latent conditions at the starting time to obtained from the time axis 420 of the input data. In this regard, some embodiments utilize standard recurrent neural network (RNN) architectures to learn temporal features from sequential data. Specifically, long short-term memory (LSTM) and gated recurrent unit (GRU) units have hidden status hₙ at the time n and are trained to sequentially update the status with that of previous time step hₙ₋₁ and signal sample at the current time step sₙ, as

$${h}_{n} = {ℛ}_{θ} ( {h}_{n - 1} , {s}_{n} ) \qquad ( 2 )$$

where [symbol] _{θ} is a RNN unit. Some embodiments are based on the realization that generally RNN assumes that the time interval for every two adjacent samples Δtₙ=tₙ−tₙ₋₁ are same Δt₁=Δt₂= . . . =Δt_{N}. However, sample inputs may often be irregularly sampled. Therefore, to deal with such irregularly sampled signals/data (i.e., Δtₙ≠Δtₙ₊₁), some embodiments provide simple exponential decay between hidden status with adjacent time steps. This models continuous dynamics of discrete signals by considering the decay of the effects of previous hidden states over time, as

$$( a ) {h}_{n}^{′} = {h}_{n - 1} {e}^{- Δ {t}_{n}} , \qquad ( 3 )$$

$$( b ) {h}_{n} = {ℛ}_{θ} ( {h}_{n}^{′} , {s}_{n} ) , n = 1 , … , N$$

Each recurrent unit of the ODE-RNN encoder 401 updates its hidden vector hₙ∈ [symbol] ^{L}^{ₕ}^{×1} with an auxiliary vector h′ₙ₊₁ and iₙ.

$${h}_{n} = {𝒢}_{{θ}_{g}} ( {h}_{n}^{′} , {i}_{n} ) , \qquad ( 4 )$$

where [symbol] _{θ}_{_{g}} can either be GRU or LSTM unit with learnable parameters θ_{G}. In standard RNN learning, the time interval between consecutive signal inputs is supposed to be equal, so h′ₙ=hₙ₊₁. However, some embodiments realize that the input samples in each stream may have temporal irregularities. To address this problem, some embodiments provide the ODE-RNN encoder 401 to utilize an ODE function [symbol] _{θ}_{ₑ} to describe the propagation of the hidden vector in a continuous-time fashion,

$$\frac{dh ( t )}{dt} = {𝒪}_{{θ}_{e}} ( h ( t ) , t ) \qquad ( 5 )$$

where the ODE function is parameterized by a multi-layer perceptron (MLP) network with learnable parameters θₑ^{c}. Utilizing a numerical ODE solver, the hidden vector hₙ₊₁ is propagated at time tₙ₊₁ to the auxiliary vector h′ₙ at the current time tₙ(note that the time is in a reversed order for estimating the initial condition):

$${h}_{n}^{′} = 𝒮 ( {𝒪}_{{θ}_{e}} , {h}_{n + 1} , ( {t}_{n}^{s} , {t}_{n + 1}^{s} ) ) = {h}_{n + 1} + {\int }_{τ = {t}_{n + 1}^{s}}^{{t}_{n}^{s}} {𝒪}_{{θ}_{e}} ( h ( τ ) , τ ) d τ \qquad ( 6 )$$

According to some embodiments, the ODE solver utilized in this regard may be Euler and Runge-Kutta solvers. By iterating between (4) and (6) the latent encoding vector may be propagated from t_{N}^{s} to t₀. Once the hidden state h₀ at t₀ is obtained, h₀ is used to generate z₀ (generically may be represented as z₀ⁱ, where i denotes the input stream) which is the initial condition 425 in the latent space for latent dynamic learning. The posterior distribution of z₀ is approximated as:

$$q {θ}_{e} ( {z}_{0} \vert {h}_{0} ) = q {θ}_{e} ( {z}_{0} \vert {s}_{N} , {s}_{N - 1} , … , {s}_{0} ) = 𝒩 ( {μ}_{{z}_{0}} , {σ}_{{z}_{0}} ) , \qquad ( 7 )$$

where the mean and standard deviation are mapped from h₀

$${μ}_{{z}_{0}} , {σ}_{{z}_{0}} = {ℳ}_{{θ}_{s}} ( {h}_{0} ) \qquad ( 8 )$$

with [symbol] denoting an MLP. The initial condition z₀∈ [symbol] ^{L}^{_{z}} is sampled

$${z}_{0} = {μ}_{{z}_{o}} + {σ}_{{z}_{o}} ⊙ ϵ , ϵ ∼ 𝒩 ( 0 , {I}_{{L}_{z}} ) \qquad ( 9 )$$

from their respective posterior mean and standard deviations.

The specifics of the latent dynamics learning are described next with reference to FIG. 4B which illustrates a workflow for generating time synchronized virtual latent dynamic states 430 and 440 from an initial latent condition z₀ⁱ 425 in a latent space, according to some embodiments. For the latent dynamics learning, some embodiments utilize another continuous-time ODE function, or latent dynamic ODE [symbol] _{d} 403 modeled by a neural network with parameters θ_{d}. The latent dynamic ODE 403, also referred to as a neural ODE is trained in a supervised manner for not only coordinate estimation but also signal reconstruction. From the initial condition z₀ⁱ 425, the ODE 403 produces latent states 430 (for reconstruction) {zₙⁱ}ₙ₌₀^{N}^{ᵢ} of the input according to the timing sequence defined by the time axis 420 of the input data. However, the latent states {zₙ^{r}^{ᵢ}}ₙ₌₀^{N}^{ᵢ} 440 for the coordinate estimation are produced in accordance with the sequence defined by the reference time axis 408. The neural ODE 403 of each autoencoder receives the same sequence of time instances as the reference time axis 408 for coordinate estimation and generates latent variables 440 at those points along the learned trajectories. First the signal-related dynamic learning blocks are queried with their respective sampling time tₙ

$${z}_{n}^{s} {=}^{Δ} {z}_{{t}_{n}^{s}} = {z}_{0} + {\int }_{{t}_{0}}^{{t}_{n}^{s}} {𝒪}_{{θ}_{d}} ( {z}_{t} , t ) dt = 𝒮 ( {𝒪}_{{θ}_{d}} , {z}_{0} , ( {t}_{0} , {t}_{n}^{s} ) ) . \qquad ( 10 )$$

The latent space is temporally continuous, and the ODE solves trajectories along arbitrary time sets. Therefore, the coordinate-related time instances tₙ^{p} can be queried for supervised training. In this case, it gives

$${z}_{n}^{p} {=}^{Δ} {z}_{{t}_{n}^{p}} = {z}_{0} + {\int }_{{t}_{0}}^{{t}_{n}^{p}} {𝒪}_{{θ}_{d}} ( {z}_{r} , t ) dt = 𝒮 ( {𝒪}_{{θ}_{d}} , {z}_{0} , ( {t}_{0} , {t}_{n}^{p} ) ) . \qquad ( 11 )$$

where the above ODE associated parameters θ_{d} is the same as the ones in (10). Some embodiments set that the initial time instance t₀ t₀≤min t₀^{s}, t₀^{p}, for in the case that coordinate samples exist prior to the time of the initial state within the window of interest, the latent dynamic ODE 403 refers times earlier than the initial state of when inferring latent trajectories, which is undesirable.

The latent states of the signal and coordinates are then passed to distinct decoders, [symbol] _{θ}_{ₛ} and [symbol] _{θ}_{_{c}} for signal reconstruction and coordinate estimation, respectively. The decoder for signal reconstruction, shown as decoder 409 in FIG. 4B, produces the reconstructed input data 406. According to some embodiments, regularizing the latent dynamic ODE 403 using both signal and coordinate losses enhances trajectory learning while capturing the relationship between attributes of the input data such as radio propagation and one or more physical properties of the device such as its physical location.

The latent dynamics learning is performed for each data type (input stream) with one pair of an ODE-RNN encoder and a latent dynamic ODE { [symbol] _{θ}_{ₑ}, [symbol] _{θ}_{_{d}}} for each stream. The ODE-RNNs sample the initial latent states z₀ⁱ∈ [symbol] according to the back-trajectory process explained above.

As to the coordinate estimation, the latent dynamic ODE 403 solves trajectories along any time sets with the initial state. Thus, starting from different initial states z₀ⁱ (one initial state corresponding to each input stream) but corresponding to the synchronized time steps defined by the reference time axis {tₙ^{p}}ₙ₌₀^{N}^{ₚ}, different latent trajectories zₙ^{p}^{ᵢ} are obtained (one latent trajectory corresponding to each input stream in the time-series input data) as follows:

$${z}_{n}^{{p}_{i}} {=}^{Δ} {z}_{{t}_{n}^{p}}^{i} = {z}_{0}^{i} + {\int }_{{t}_{0}}^{{t}_{n}^{p}} {𝒪}_{{θ}_{d}^{i}} ( {z}_{t}^{i} , t ) dt , \qquad ( 12 )$$

Some embodiments ensure that the initial latent representation of the signal dynamics fully relies on the entire input signal sequence by ODE-RNN architecture, and that it follows a well-defined distribution via the custom loss function. Therefore, fusing the post-ODE dynamic pathways (latent states 440 corresponding to coordinate estimation) turns out to be highly beneficial for downstream tasks such that the fused dynamic pathway gains more complementary perspective captured by different modalities, and dynamics-level fusion is much context aware because their latent representation completely trace time-continuous evolution of systems, which cannot be achieved by discrete frame-to-frame feature concatenation.

FIG. 4C illustrates a workflow for performing post-ODE fusion of time synchronized virtual latent dynamic states 440A-440M to generate a unified latent space, according to some embodiments. The post ODE fusion block 405 generates the unified latent space by a sequence of projection, concatenation and compression operations. To this end, a three-layer non-linear projection with learnable weights and biases, namely, latent fusion block 405 is employed. First the aligned post-ODE states 440A-440M are projected into higher dimensions:

$${\hat{z}}_{n}^{i} = tanh ( {W}^{i} {z}_{n}^{i} + {b}^{i} ) , n = 1 , … , {N}_{p} , \qquad ( 13 )$$

with learnable matrices Wⁱ, bⁱ and

$$tanh ( x ) = \frac{( {e}^{x} - {e}^{- x} )}{( {e}^{x} + {e}^{- x} )} .$$

The projected latent states are then concatenated, and finally compressed into a fused latent state 407 \hat{z}ₙ at tₙ^{p}. Considering two streams in the input data 402,

$${\hat{z}}_{n} = {W}_{2}^{f} ( tanh ( {{W}_{1}^{f} [ {\hat{z}}_{n}^{i 1} , {\hat{z}}_{n}^{i 2} ]}^{T} + {b}_{1}^{f} ) ) + {b}_{2}^{f} \qquad ( 14 )$$

with another learnable weights W₁^{f}, W₂^{f} and biases b₁^{f}, b₂^{f}. The latent fusion block 405 is time-independent and shared across all time instances.

As can be seen from the above, multi-stream data fusion may be achieved by encoder-decoder type RNN architecture: training each sequence of the multi-stream with two encoding RNNs, obtaining the final hidden states for each stream, combining the final hidden states followed by latent fusion at dynamics-level. According to some embodiments, the output of the latent fusion block 405 may be used for continuous downstream tasks such as for estimating the coordinates with another decoding RNN.

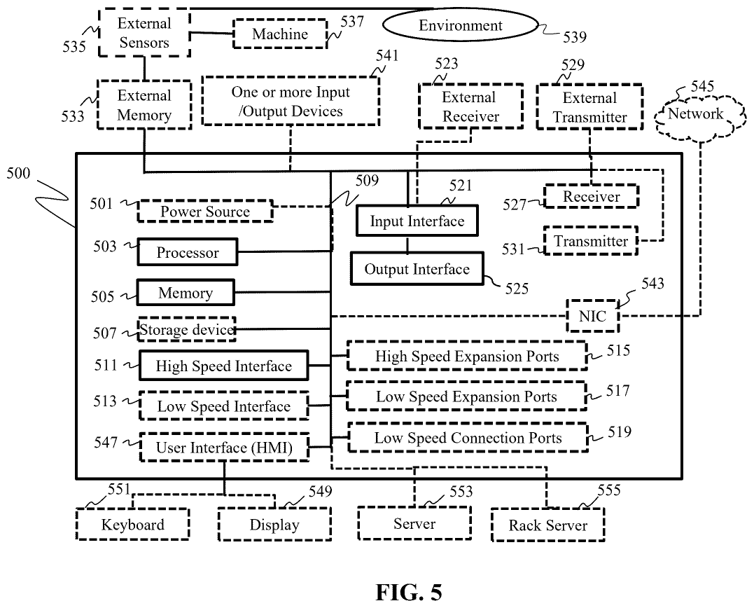

FIG. 5 shows a schematic diagram of an Artificial Intelligence (AI) system 500 for tracking the state of the device with continuous-time dynamics, according to some embodiments of the present disclosure. The AI system 500 includes a power source 501, a processor 503, a memory 505, a storage device 507, all connected to a bus 509. Further, a high-speed interface 511, a low-speed interface 513, high-speed expansion ports 515 and low speed connection ports 517, can be connected to the bus 509. In addition, a low-speed expansion port 519 is in connection with the bus 509. Further, an input interface 521 can be connected via the bus 509 to an external receiver 523 and an output interface 525. A receiver 527 can be connected to an external transmitter 529 and a transmitter 531 via the bus 509. Also connected to the bus 509 can be an external memory 533, external sensors 535, machine(s) 537, and an environment 539. Further, one or more external input/output devices 541 can be connected to the bus 509. A network interface controller (NIC) 543 can be adapted to connect through the bus 509 to a network 545, wherein data or other data, among other things, can be rendered on a third-party display device, third party imaging device, and/or third-party printing device outside of the AI system 500.

The memory 505 may store instructions that are executable by the AI system 500 and any data that can be utilized by the methods and systems of the present disclosure. The memory 505 can include random access memory (RAM), read only memory (ROM), flash memory, or any other suitable memory systems. The memory 505 can be a volatile memory unit or units, and/or a non-volatile memory unit or units. The memory 505 may also be another form of computer-readable medium, such as a magnetic or optical disk.

The storage device 507 can be adapted to store supplementary data and/or software modules used by the computer device 500. The storage device 507 can include a hard drive, an optical drive, a thumb-drive, an array of drives, or any combinations thereof. Further, the storage device 507 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 503), perform one or more methods, such as those described above.

In an embodiment, the storage device 507 is configured to store a neural network having an autoencoder architecture (e.g., the autoencoder 315) adapted for dynamic transformation of time series input data from an input state space indicative of the state of the device into an output state space indicative of the state of the device. The memory 505 may store instructions that cause the processor 503 to execute the neural network having the autoencoder architecture, train the neural network, or both.

The AI system 500 can be linked through the bus 509, optionally, to a display interface or user Interface (HMI) 547 adapted to connect the AI system 500 to a display device 549 and a keyboard 551, wherein the display device 549 can include a computer monitor, camera, television, projector, or mobile device, among others. In some implementations, the computer device 500 may include a printer interface to connect to a printing device, wherein the printing device can include a liquid inkjet printer, solid ink printer, large-scale commercial printer, thermal printer, UV printer, or dye-sublimation printer, among others.

The high-speed interface 511 manages bandwidth-intensive operations for the AI system 500, while the low-speed interface 513 manages lower bandwidth-intensive operations. Such allocation of functions is an example only. In some implementations, the high-speed interface 511 can be coupled to the memory 505, the user interface (HMI) 545, and to the keyboard 551 and the display 549 (e.g., through a graphics processor or accelerator), and to the high-speed expansion ports 515, which may accept various expansion cards via the bus 509. In an implementation, the low-speed interface 513 is coupled to the storage device 507 and the low-speed expansion ports 517, via the bus 509. The low-speed expansion ports 517, which may include various communication ports (e.g., USB, Bluetooth, Ethernet, wireless Ethernet) may be coupled to the one or more input/output devices 541. The AI system 500 may be connected to a server 553 and a rack server 555. The AI system 500 may be implemented in several different forms. For example, the AI system 500 may be implemented as part of the rack server 555.

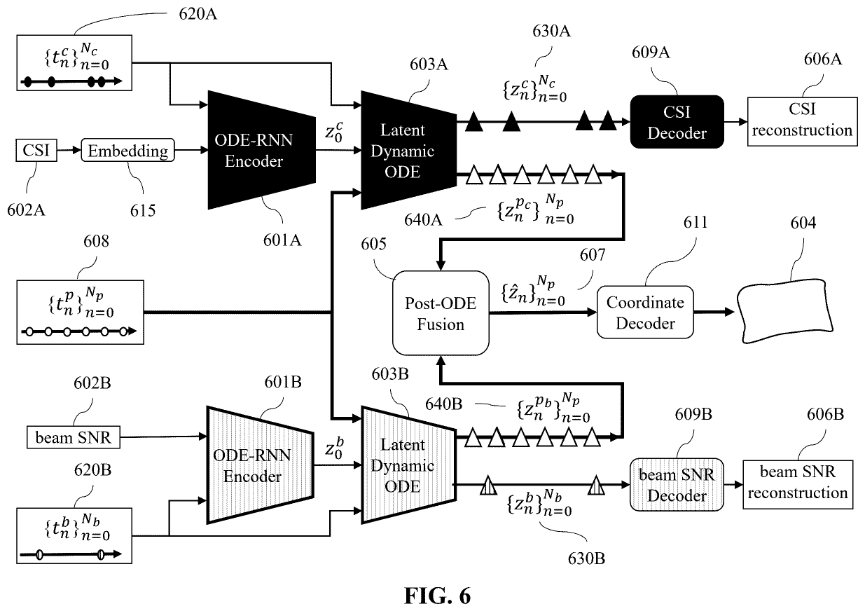

An example configuration of the AI system 500 may be understood with reference to a use case for fusion of wireless signals for indoor localization. FIG. 6 shows an asynchronous neural dynamic fusion (NDF) framework for multi-band Wi-Fi waveforms for object trajectory estimation, according to some embodiments. The NDF framework utilizes an adapted architecture of the AI system described previously with reference to FIGS. 1A-4C. The NDF framework formulates trajectory estimation as a regression with asynchronous channel state information (CSI) 602A and beam signal to noise ratio (SNR) 602B sequences. The framework utilizes two autoencoder arms each comprising an ODE-RNN encoder (601A or 601B) and a latent dynamic ODE (603A or 603B) for each of the CSI and beam SNR sequences.

At time tₙ^{b}, a set of M beam SNR values bₙ=[b₁, b₂, . . . b_{M}]^{T}∈ [symbol] ^{M}^{_{b}}^{×1}, each corresponding to one beam training pattern is collected. For CSI, at time tₙ^{c}, a channel frequency response matrix Cₙ∈ [symbol] ^{N}^{_{Tx}}^{N}^{_{Rx}}^{×N}^{ₛ} over Nₛ OFDM subcarriers, N_{Tx} transmitting antennas, and N_{Rx} receiving antennas, is collected. For a time window of length Δ [symbol] , N_{b} beam SNR samples and N_{c} CSI samples are collected with which the AI system aims to estimate the trajectory at Nₚ time instances tₙ^{p}; n=1, . . . , Nₚ. In some scenarios, N_{b} and N_{c} may vary from one time window to another due to sampling irregularity.

The problem of interest is to estimate the coordinate of a trajectory at any time point tₙ^{p} within the time window with the beam SNR and CSI input sequences along with their respective time stamps,

$${\{ {b}_{n} , {t}_{n}^{b} \}}_{n = 0}^{{N}_{b}} , {\{ {c}_{n} , {t}_{n}^{c} \}}_{n = 0}^{{N}_{c}} \to {\{ {p}_{n} \}}_{n = 0}^{{N}_{p}} , \qquad ( 15 )$$

where pₙ=[xₙ, [symbol] ₙ]^{T} consists of two-dimensional coordinates at tₙ^{p}. The problem involves sequence-based, where the entire trajectory over a time window of interest is estimated from the consecutive CSI and beam SNR measurements. As sequence-based fusion, standard recurrent neural network (RNN) architectures can be used to learn temporal features from sequential signals.

In some scenarios, CSI 602A may suffer from inevitable noises caused by hardware imperfections and high complexity of multipath environment, and noise calibration is an essential part of preprocessing. Especially, due to incomplete synchronization between Tx and Rx, CSI phase suffers from inevitable phase offsets, including Carrier Frequency Offset (CFO) and Sample Time Offset (STO). Some embodiments employ a sample time offset (STO) elimination method as a pre-processing step, to eliminate the linear phase offset, and CSI conjugate multiplication to cancel out packet-wise random phase offset and improve the stability of the waveform.

Since the dimensionality of CSI is much larger than that of beam SNR, some embodiments introduce CSI embedding 615 after the pre-processing. Informative feature in CSI is needed to be preserved as well as possible, therefore, the embedding is performed by a convolutional autoencoder such as the one described with reference to FIG. 4A, which provides embedded feature according to eqn. (1) as:

$${ε}_{{θ}_{c}^{e}} ( {c}_{n} ) = , ∈ {{M}_{c} \times 1}^{}$$

where M_{c} is the length of the embedded CSI feature.

The ODE-RNN encoders 601A and 601B operate in a manner similar to the encoder 401 of FIG. 4A and each of them takes a reversed input sequences s_{N}, s_{N-1}, . . . , s₀ to estimate the initial latent conditions at the starting time t₀ obtained from the respective time axis 620A or 620B of the input data 602A or 602B. Each recurrent unit of each of the ODE-RNN encoders 601A and 601B updates its hidden vector in the manner described with reference to eqn. 4 of FIG. 4A. By iterating between (4) and (6) the latent encoding vector may be propagated from t_{N}^{s} to t₀. Once the hidden state h₀^{c} and h₀^{b} at t₀ is obtained for each of the CSI and beam SNR, the hidden state h₀^{c} and h₀^{b} are used to generate the hidden state z₀^{c} and z₀^{b}, respectively which are the initial condition for each stream in the latent space for latent dynamic learning. The posterior distribution of each initial condition z₀^{c} and z₀^{b} is approximated as per eqn. (7)-(9).

Corresponding to each ODE-RNN encoder 601A and 601B, the NDF framework utilizes another continuous-time ODE function, or latent dynamic ODE [symbol] _{d} 603A and 603B respectively with each latent dynamic ODE 603A or 603B modeled by a neural network with parameters θ_{d}. Each of the latent dynamic ODE 603A and 603B, also referred to as a neural ODE, is trained in a supervised manner for not only coordinate estimation but also signal reconstruction. The latent dynamic ODE 603A produces latent states 630A (for CSI reconstruction) {zₙ^{c}}ₙ₌₀^{N}^{_{c}} from the initial condition z₀^{c} according to the timing sequence defined by the time axis 620A of the CSI sequence 601A, while the latent dynamic ODE 603B produces latent states 630B (for beam SNR reconstruction) {zₙ^{b}}ₙ₌₀^{N}^{_{b}} from the initial condition z₀^{b} according to the timing sequence defined by the time axis 620B of the beam SNR sequence 601B. However, for the coordinate estimation, the latent states {zₙ^{p}^{_{c}}}ₙ₌₀^{N}^{ₚ} 640A corresponding to the CSI 601A and the latent states {zₙ^{p}^{_{b}}}ₙ₌₀^{N}^{ₚ} 640B corresponding to the beam SNR 601B are produced in accordance with the sequence defined by the reference time axis 608. Thus, each of the neural ODEs 603A and 603B receives the same sequence of time instances as the reference time axis 608 for coordinate estimation and generates latent variables 640A and 640B at those points along the learned trajectories according to eqn. (11).

For each signal (i.e., CSI and beam SNR), the latent states of the signal and coordinates are then passed to distinct decoders, [symbol] _{θ}_{ₛ} and [symbol] _{θ}_{_{c}} for signal reconstruction and coordinate estimation, respectively. As is shown in FIG. 6, the CSI decoder 609A produces the reconstructed CSI 606A while the beam SNR decoder 609B produces the reconstructed beam SNR 606B.

For coordinate estimation, the latent dynamic ODE 603A and 603B are each capable of solving trajectories along any time sets with a respective initial state. Eqn. (12) gives two latent trajectories, starting from different initial state z₀^{c} and z₀^{b} but corresponding to the synchronized time steps defined by the reference time axis {tₙ^{p}}ₙ₌₀^{N}^{ₚ} as:

$${z}_{n}^{{p}_{c}} {=}^{Δ} {z}_{{t}_{n}^{p}}^{c} = {z}_{0}^{c} + {\int }_{{t}_{0}}^{{t}_{n}^{p}} {𝒪}_{{θ}_{d}^{c}} ( {z}_{t}^{c} , t ) dt$$

$${z}_{n}^{{p}_{b}} {=}^{Δ} {z}_{{t}_{n}^{p}}^{b} = {z}_{0}^{b} + {\int }_{{t}_{0}}^{{t}_{n}^{p}} {𝒪}_{{θ}_{d}^{b}} ( {z}_{t}^{b} , t ) dt$$

The post ODE fusion block 605 generates the unified latent space by a sequence of projection, concatenation and compression operations. To this end, a three-layer non-linear projection with learnable weights and biases, namely, latent fusion block 605 is employed. First the aligned post-ODE states 640A and 640M are projected into higher dimensions as per eqn. (13) as:

$${\hat{z}}_{n}^{c} = tanh ( {W}^{c} {z}_{n}^{c} + {b}^{c} ) , n = 1 , … , {N}_{p} , \qquad ( 16 )$$

$${\hat{z}}_{n}^{b} = tanh ( {W}^{b} {z}_{n}^{b} + {b}^{b} ) , n = 1 , … , {N}_{p} , \qquad ( 17 )$$

These projected latent states are then concatenated, and finally compressed into a fused latent state 607 \hat{z}ₙ at tₙ^{p}. The output of the latent fusion block 605 is processed for estimating the coordinates of the device with another decoding RNN 611 to obtain a trajectory 604.

As to the signal reconstruction, the latent dynamic ODEs for CSI and beam SNR (603A and 603B) yield latent sequences according to Eq. (7). Therefore, from the latent dynamic learning and fusion blocks, the latent dynamic states in three distinct sets of time instances are obtained as:
zₙ^{b}, n=1, . . . , N_{b}, at the beam SNR sampling time tₙ^{b};
zₙ^{c}, n=1, . . . , N_{c}, at the CSI sampling time tₙ^{c};
\hat{z}ₙ, n=1, . . . , Nₚ, at shared time instances tₙ^{p}.

Some embodiments train the latent dynamic ODEs in a supervised manner with CSI and beam SNR waveform reconstruction and coordinate estimation, so that each ODE captures the temporal evolution of latent representation while considering the relationship between RF propagation and physical object's/device's locations. Therefore, a multi-head decoding structure that consists of separate MLP heads for signal and coordinate decoding may be employed. Such a multi-head decoding structure includes the CSI decoder 609A, the beam SNR decoder 609B, and the coordinate decoder 611.

For the latent representations corresponding to signal time instances, two separate MLP heads [symbol] _{θ}_{_{b}}, [symbol] _{θ}_{_{c}}, respectively may be used (i.e., [symbol] _{θ}_{_{c}} for CSI and [symbol] _{θ}_{_{b}} for beam SNR) to decode them back to the waveform as

$${\hat{b}}_{n} = {𝒟}_{{θ}_{b}} ( {z}_{n}^{b} ) , n = 1 , … , {N}_{b} \qquad ( 18 )$$

$${\hat{c}}_{n} = {𝒟}_{{θ}_{c}} ( {z}_{n}^{c} ) , n = 1 , … , {N}_{c} \qquad ( 19 )$$

For the fused latent states corresponding to coordinate estimation, another MLP head [symbol] _{θ}_{ₚ} is used to project them to coordinate estimations as

$${\hat{p}}_{n} = {𝒟}_{{θ}_{p}} ( {\hat{z}}_{n} ) , n = 1 , … , {N}_{p} . \qquad ( 20 )$$

It may be noted that the error between the estimated coordinates 604 and the ground truth is propagated back to the latent dynamic ODEs 603A, 603B corresponding to CSI and beam SNR, respectively, through the gradient. In this way, the two latent dynamic ODEs 603A, 603B do not learn completely independently; instead, they can complementarily exchange information about the dynamics they have learned through the supervised learning of the coordinates, to make the best of the effect of dynamics fusion.

It may be noted that estimating the posterior distribution q(z₀|h₀) defines the initial latent state of the target trajectory. q(z₀|h₀) is desired to follow the standard normal distribution for the following two reasons. First, the distributions of CSI and beam SNR sequences are unknown a priori. Projecting these sequences onto latent spaces with standard normal distribution stochastically regularizes the starting points of the trajectory to a standardized range and enables stable solving of the latent dynamic ODE and the subsequent decoders. Second, dynamics-level fusion of CSI and beam SNR is desired. Though the latent stating points for both modalities at least follow normal distributions according to Eqn. (6), if their scale is not regularized and easily changed dynamically in training, the distribution of fused latent dynamics also becomes unstable, possibly leading the performance degradation. Taking these two reasons into account, various embodiments consider the loss function for training, incorporating distribution regularization of q(z₀|h₀) as well as signal reconstruction and coordinate estimation.

Here, let s={sₙ, tₙ}ₙ₌₀^{N} and q(z₀|h₀)=q(z₀|s) follows. As to the signal reconstruction, the original objective is to maximize the log-likelihood function log p(s). However, the distribution of s is generally unknown and too complex to directly estimate. Therefore, some embodiments formulate transform log p(s) with q(z₀|s) as the following:

$$log p ( s ) = log p ( s ) \int q ( {z}_{0} \vert s ) {dz}_{0}$$

$$= \int q ( {z}_{0} \vert s ) log \frac{p ( {z}_{0} \vert s ) p ( s )}{p ( {z}_{0} \vert s )} {dz}_{0} \qquad i )$$

$$= \int q ( {z}_{0} \vert s ) log \frac{p ( s , {z}_{0} )}{p ( {z}_{0} \vert s )} {dz}_{0} \qquad ii )$$

$$= \int q ( {z}_{0} \vert s ) ( log \frac{q ( {z}_{0} \vert s )}{p ( {z}_{0} \vert s )} + log \frac{p ( s , {z}_{0} )}{p ( {z}_{0} \vert s )} ) {dz}_{0} \qquad iii )$$

$$= {D}_{KL} [ q ( {z}_{0} \vert s ) ‖ p ( {z}_{0} \vert s ) ] + \int q ( {z}_{0} \vert s ) log \frac{p ( s , {z}_{0} )}{p ( {z}_{0} \vert s )} {dz}_{0} \qquad iv )$$

where D_{KL}[⋅∥⋅] is KL divergence between two given distributions. Given that D_{KL}[q(z₀|s)∥p(z₀|s)]≥0 based on Jensen's inequality, the lower bound of log p(s) follows as:

$$log p ( s ) \geq \int q ( {z}_{0} \vert s ) log \frac{p ( s , {z}_{0} )}{p ( {z}_{0} \vert s )} {dz}_{0}$$

where the right side is called ELBO. Another ELBO representation may also be deduced as the following:

$$ELBO = \int q ( {z}_{0} \vert s ) log q ( s \vert {z}_{0} ) {dz}_{0} - \int q ( s \vert {z}_{0} ) log \frac{p ( {z}_{0} \vert s )}{q ( {z}_{0} )} {dz}_{0} = {𝔼}_{q ( {z}_{0} \vert s )} [ log p ( s , {z}_{0} ) ] - {D}_{KL} [ q ( {z}_{0} \vert s ) ‖ p ( {z}_{0} ) ] .$$

Now the objective is reasonably replaced with maximizing ELBO to suppress the lower bound of log p(s). As to the maximization of the first term, an independent assumption may be invoked over the samples in the signal sequence, and imply that

$$log p ( s \vert {z}_{0} ) = log p ( s \vert {z}_{0} ) = log p ( {s}_{0} , {s}_{1} , … , {s}_{N} \vert {z}_{0} ) = {\sum }_{n} log p ( {s}_{n} \vert {z}_{0} ) = {\sum }_{n} {\sum }_{k} log p ( {s}_{n , k} \vert {z}_{0} )$$

where k∈[1, 2, . . . , K] denotes the index of the element in a signal sample and s_{n,k} is the k^{th} element at time n. Without losing generality, it can be assumed that the likelihood function for each element p(s_{n,k}|z₀) follows a Laplace distribution as:

$$p ( {s}_{n , k} \vert {z}_{0} ) = \frac{1}{2 {b}_{s}} exp ( - \frac{\vert {s}_{n , k} - \vert}{{b}_{s}} )$$

where bₛ∈ [symbol] is a scale parameter and [symbol] = [symbol] _{θ}_{ₛ}(zₙ^{s}) is the reconstructed signal derived from z₀. Therefore, Eq. (11) may be transformed as:

$$log p ( s \vert {z}_{0} ) = - nk log 2 {b}_{s} - \frac{{‖ s - \hat{s} ‖}_{1}}{{b}_{s}}$$

where ∥⋅∥₁ denotes the l₁ norm. Simply given that bₛ=1, the first term of ELBO is finalized as

$$= {𝔼}_{q ( {z}_{0} \vert s )} [ log p ( s \vert {z}_{0} ) ] ∝ - {\sum }_{n = 1}^{N} {‖ s - \hat{{s}_{n}} ‖}_{1}$$

Maximizing this log-likelihood is equivalent to minimizing mean absolute error (MAE) loss between true and reconstructed signal. Eqn. (9) to (13) for coordinate estimation and obtain

$${𝔼}_{q ( {z}_{0} \vert p )} log p ( p \vert {z}_{0} ) ∝ - {\sum }_{n = 1}^{{N}_{p}} {‖ {p}_{n} - ‖}_{1}$$

For the second term in ELBO, as mentioned previously, q(z₀|s) is forced to follow the standard normal distribution, hence it may be assumed that p(z₀) is the prior which satisfies p(z₀)˜ [symbol] (0, I_{L}_{_{z}}) and thereby it can be deduced that

$${D}_{KL} [ q ( {z}_{0} \vert s ) ‖ p ( {z}_{0} ) ] = {\sum }_{l = 1}^{{L}_{z}} {D}_{KL} [ 𝒩 ( {μ}_{l} , {σ}_{l} ) ‖ 𝒩 ( 0 , I ) ]$$

$$\frac{1}{2} {\sum }_{l = 1}^{{L}_{z}} ( {μ}_{l}^{2} + {σ}_{l}^{2} - 1 - ln ( {σ}_{l}^{2} ) )$$

where μₗ, σₗ are the lth elements of μ_{z}_{ₒ}, σ_{z}_{ₒ}, respectively.

Summing up what is deduced through Eq. (9) to (19), the completed training objective is to maximize the customized ELBO by minimizing the following loss function

$$ℒ = {λ}_{1} {\sum }_{n = 1}^{N} {‖ {s}_{n} - \hat{{s}_{n}} ‖}_{1} + {\sum }_{n = 1}^{{N}_{p}} {‖ {p}_{n} - \hat{{p}_{n}} ‖}_{1} + {λ}_{2} {\sum }_{l = 1}^{{L}_{z}} ( {μ}_{l}^{2} + {σ}_{l}^{2} - 1 - ln ( {σ}_{l}^{2} ) )$$

where λ₁, λ₂ are hyperparameters used to weight the contributions of the signal reconstruction loss and KL divergence term respectively. To achieve high accuracy in estimating the target location, λ₁ and λ₂ may be set to balance the scale of the loss terms and place more emphasis on the coordinate estimation error.

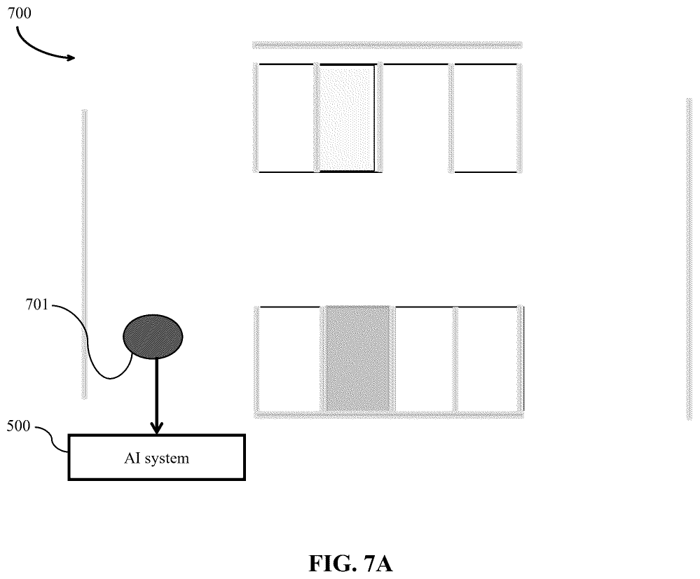

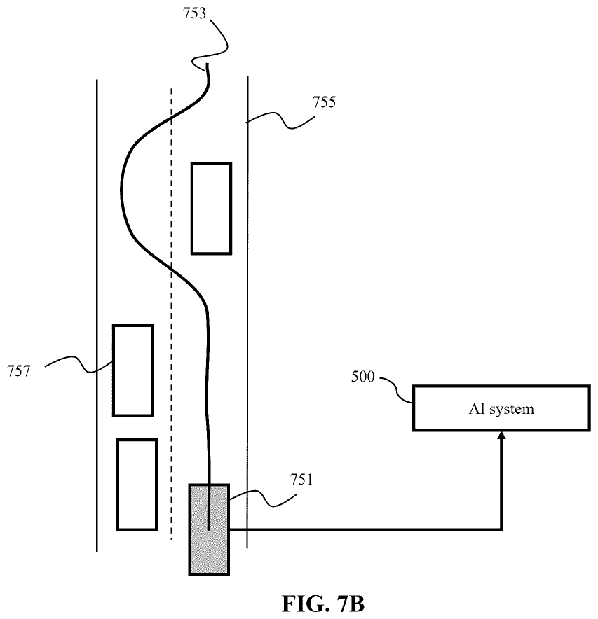

Thus, the NDF framework illustrated in FIG. 6 provides a robust framework for fusing multimodal and multidimensional signals so as to aid in challenging downstream tasks. The estimated coordinates of the device find applications in a plethora of end use cases, a few of which are described next in FIGS. 7A and 7B.

In an embodiment, the device may be a mobile robot, and the AI system can be used to track a state of the mobile robot, e.g., the location of the mobile robot, in an indoor space. In other words, the AI system can be used for indoor localization of the mobile robot.

FIG. 7A illustrates an example use case for indoor localization of a mobile robot 701 in an indoor space 700, using the AI system 500, according to some embodiments of the present disclosure. The indoor space 700 may be an autonomous factory, a warehouse, or a smart home, where asset (such as robot) tracking is required or crucial. The mobile robot 701 is communicatively coupled to the AI system 500.

The AI system includes the autoencoder 315. The mobile robot 701 includes a Wi-Fi receiver. The AI system 500 receives Wi-Fi measurements of the Wi-Fi receiver and applies the Wi-Fi measurements as input data to the autoencoder 315. The autoencoder 315 processes the Wi-Fi measurements, and outputs coordinates of the mobile robot as output data. The mobile robot 701 may be tracked based on the coordinates of the mobile robot. Here, the state space of the input data is a signal space parameterized on the Wi-Fi measurements of the Wi-Fi receiver, and the state space of the output data is a location space parametrized on the coordinates of the mobile robot. Thus, the autoencoder 315 performs state space transformation by transforming data from the signal space to the location space.

Additionally, in some embodiments, the device may be a vehicle or a part thereof, and the AI system 500 may be used for tracking a location of the vehicle. Here, the input state space is a signal space parametrized on acceleration measurements of the vehicle, and the output state space is a location space parametrized on coordinates of the vehicle.

FIG. 7B illustrates another example use case for tracking of a location of a vehicle 751 using the AI system 500, according to some embodiments of the present disclosure. The vehicle 751 may be configured to move along a trajectory 753 on a road 755 while avoiding obstacle vehicles 757. The AI system 500 is communicatively coupled to the vehicle 751. The AI system 500 receives measurements of acceleration of the vehicle 751. The AI system 500 processes the received measurements of acceleration of the vehicle 751 with the autoencoder 315 and outputs coordinates of the vehicle 751. Based on the coordinates of the vehicle 751, the location of the vehicle 751 may be tracked.

The description provides exemplary embodiments only, and is not intended to limit the scope, applicability, or configuration of the disclosure. Rather, the description of the exemplary embodiments intends to provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. The computer storage medium can be a machine-readable storage device, a machine-readable storage substrate, a random or serial access memory device, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship with each other.

Although the present disclosure has been described with reference to certain preferred embodiments, it is to be understood that various other adaptations and modifications can be made within the spirit and scope of the present disclosure. Therefore, it is the aspect of the appended claims to cover all such variations and modifications as come within the true spirit and scope of the present disclosure.

What is claimed is:

1. An artificial intelligence (AI) system for tracking a state of a device with continuous-time latent dynamics, the AI system including a neural network having an autoencoder architecture adapted for dynamic transformation of time series input data from an input state space indicative of the state of the device into an output state space indicative of a state trajectory of the device, comprising: at least one processor; and a memory having instructions stored thereon that cause the at least one processor to execute the neural network, train the neural network, or both, the autoencoder architecture comprising:
multiple neural ordinary differential equation (ODE) subnetworks, each of the neural ODE subnetworks includes a neural ODE implemented as a recurrent neural network (RNN) architecture transforming unsynchronized time-series input data into time-series latent representations synchronized in time with the time-series latent representations produced by others of the multiple neural ODE subnetworks;
a post ODE fusion module configured to fuse the synchronized time-series latent representations of the multiple ODE-RNN subnetworks; and
a decoder configured to decode changes in the state of the device from the fused synchronized time-series latent representations to form the state trajectory of the device.

2. The AI system of claim 1, wherein each neural ODE subnetwork of the multiple neural ODE subnetworks comprises:
an encoder configured to encode each input data point of the time series input data from the input state space into latent space to produce latent data points indexed in time according to time indices of corresponding input data points and propagate the latent data points backward in time with the neural ODE approximating dynamics of the device in the latent space to estimate an initial point of latent dynamics of the device in the latent space; and
a latent dynamic subnetwork configured to propagate the initial point of latent dynamics of the device forward in time till time indices of interest using the neural ODE to produce the time-series latent representations of the state trajectory of the device at the time indices of interest.

3. The AI system of claim 2, wherein the encoder comprises:
an embedding layer configured to produce embeddings of the time series input data using a convolutional autoencoder, wherein the embeddings are produced in a reverse order of the time series input data; and
a neural ODE encoder configured to encode each embedding of the time series input data to produce the latent data points indexed in time, wherein the latent data points are produced in the same order of the time series input data.

4. The AI system of claim 1, wherein the multiple neural ODE subnetworks include a first neural ODE subnetwork transforming the input data of a first input state space and a second neural ODE subnetwork transforming the input data of a second input state space, wherein the first input state space is different from the second input state space.

5. The AI system of claim 4, wherein the first input state space includes channel state information (CSI) measurements and wherein the second input state space includes beam signal to noise ratio (SNR) measurements.

6. The AI system of claim 5,
wherein the neural network is a multi-head decoder neural network,
wherein the first neural ODE subnetwork further comprises a CSI decoder configured to reconstruct the CSI measurements from the time-series latent representations of the state trajectory of the first neural ODE subnetwork; and
wherein the second neural ODE subnetwork further comprises a beam SNR decoder configured to reconstruct the beam SNR measurements from the time-series latent representations of the state trajectory of the second neural ODE subnetwork.

7. The AI system of claim 6,
wherein the first neural ODE subnetwork is configured to generate a first latent trajectory for the CSI measurements from a first initial point of latent dynamics of the device in a latent space,
wherein the second neural ODE subnetwork is configured to generate a second latent trajectory for the beam SNR measurements from a second initial point of latent dynamics of the device in the latent space,
wherein each of the first latent trajectory and the second latent trajectory comprises a plurality of latent states, and
wherein for each latent state of the first latent trajectory there exists a latent state in the second latent trajectory that is aligned in time.

8. The AI system of claim 7, wherein the post ODE fusion module is further configured to:
project each latent state of the first latent trajectory and the second latent trajectory into one or more dimensions; and
concatenate the projected latent states to obtain a fused latent state at each instance of the time indices of interest.

9. The AI system of claim 8, wherein the multi-head decoder neural network further comprises a coordinate decoder configured to project the fused latent states to a plurality of coordinate estimates for the device.

10. The AI system of claim 9, wherein the at least one processor is further configured to:
compute a first reconstruction loss for the first neural ODE subnetwork, based on the reconstructed CSI measurements and the plurality of coordinate estimates for the device; and
compute a second reconstruction loss for the second neural ODE subnetwork, based on the reconstructed CSI measurements and the plurality of coordinate estimates for the device.

11. The AI system of claim 10, wherein the at least one processor is further configured to train the first neural ODE subnetwork by propagating back the first reconstruction loss to the first neural ODE subnetwork and train the second neural ODE subnetwork by propagating back the second reconstruction loss to the second neural ODE subnetwork.

12. The AI system of claim 1, wherein the device is a mobile robot including a Wi-Fi receiver, wherein the input state space is a signal space parameterized on Wi-Fi measurements of the Wi-Fi receiver, and wherein the output state space is a location space parametrized on coordinates of the mobile robot.

13. The AI system of claim 1, wherein the device is a vehicle, wherein the input state space is a signal space parametrized on acceleration measurements of the vehicle, and wherein the output state space is a location space parametrized on coordinates of the vehicle.

14. A method for tracking a state of a device with continuous-time latent dynamics, the method utilizing an artificial intelligence (AI) system including a neural network having an autoencoder architecture adapted for dynamic transformation of time series input data from an input state space indicative of the state of the device into an output state space indicative of a state trajectory of the device, the method comprising:
transforming by each subnetwork of a plurality of neural ordinary differential equation (ODE) subnetworks, unsynchronized time-series input data into time-series latent representations synchronized in time with the time-series latent representations produced by other neural ODE subnetworks;
fusing the synchronized time-series latent representations of the plurality of neural ODE subnetworks; and
decoding changes in the state of the device from the fused synchronized time-series latent representations to form the state trajectory of the device.

15. The method of claim 14, further comprising:
encoding by each subnetwork of the plurality of neural ODE subnetworks, each input data point of the time series input data from the input state space into latent space to produce latent data points indexed in time according to time indices of corresponding input data points
propagating the latent data points backward in time with a neural ODE approximating dynamics of the device in the latent space to estimate an initial point of latent dynamics of the device in the latent space; and
propagating using a latent subnetwork, the initial point of latent dynamics of the device forward in time till time indices of interest using the neural ODE to produce the time-series latent representations of the state trajectory of the device at the time indices of interest.

16. The method of claim 14, wherein transforming the unsynchronized time-series input data into time-series latent representations comprises:
transforming by a first neural ODE subnetwork, the input data of a first input state space; and
transforming by a second neural ODE subnetwork, the input data of a second input state space,
wherein the first input state space is different from the second input state space.

17. The method of claim 16, wherein the first input state space includes channel state information (CSI) measurements, and the second input state space includes beam signal to noise ratio (SNR) measurements, and wherein the method further comprises:
reconstructing the CSI measurements from the time-series latent representations of the state trajectory of the first neural ODE subnetwork; and
reconstructing the beam SNR measurements from the time-series latent representations of the state trajectory of the second neural ODE subnetwork.

18. The method of claim 17, further comprising:
generating a first latent trajectory for the CSI measurements from a first initial point of latent dynamics of the device in a latent space;
generating a second latent trajectory for the beam SNR measurements from a second initial point of latent dynamics of the device in the latent space,
wherein each of the first latent trajectory and the second latent trajectory comprises a plurality of latent states, and
wherein for each latent state of the first latent trajectory there exists a latent state in the second latent trajectory that is aligned in time.

19. The method of claim 18, wherein fusing the synchronized time-series latent representations comprises:
projecting each latent state of the first latent trajectory and the second latent trajectory into one or more dimensions; and
concatenating the projected latent states to obtain a fused latent state at each instance of the time indices of interest.

20. A non-transitory computer readable storage medium embodied thereon a program executable by a processor for performing a method for tracking a state of a device with continuous-time latent dynamics, the method utilizing an artificial intelligence (AI) system including a neural network having an autoencoder architecture adapted for dynamic transformation of time series input data from an input state space indicative of the state of the device into an output state space indicative of a state trajectory of the device, the method comprising:
transforming by each subnetwork of a plurality of neural ordinary differential equation (ODE) subnetworks, unsynchronized time-series input data into time-series latent representations synchronized in time with the time-series latent representations produced by other neural ODE subnetworks;
fusing the synchronized time-series latent representations of the plurality of neural ODE subnetworks; and
decoding changes in the state of the device from the fused synchronized time-series latent representations to form the state trajectory of the device.
